(19) United States
(12) Patent Application Publication
(10) Pub. No.: US 2004/0237114 A1
(43) Pub. Date: Nov. 25, 2004

(54) Television system with acoustic back-link

(76) Inventor: Jonathan Drazin, Whitchurch-on-Thames (GB)

Correspondence Address: FISH & NEAVE, 1251 AVENUE OF THE AMERICAS, 50TH FLOOR, NEW YORK, NY, 10020-1105, US

(21) Appl. No.: 10/483,290

(22) PCT Filed: Jul. 15, 2002
(86) PCT No.: PCT/GB02/03275

(30) Foreign Application Priority Data
Jul. 13, 2001 (GB) 0117170.1
Feb. 5, 2002 (GB) 0202685.4

(51) Int. Cl. H04N 7/16; H04H 9/00; H04N 7/173

(52) U.S. Cl. 725/105; 725/135; 725/13

(57) ABSTRACT

An interactive television system having a television or TVPC or any other addressable television terminal (STB), the system being operable to use an acoustic back-link to enable communication between the television terminal (STB) and a remote service provider. The television terminal (STB) is operable to generate acoustic signals that are representative of an interactive viewer selection. These acoustic signals are forwarded to a service provider (12) via an audio telephonic link. Responses to the viewer initiated acoustic signals are forwarded from the service provider (12) to the viewer via a television network (14).

The present invention relates to an interactive television system that uses a supplementary return path for responses to actions provided via a television system, and in particular via a set top box (STB).

Digital STBs have been in wide scale use for a number of years. In many cases, STBs contain a telephone or cable modem to provide a back-link function that allows information to be sent back to a remote data centre. This may be used to send confirmation of interactive transactions such as the ordering of goods or services, for example ordering a movie or a pizza, or a request for subscription to a premium pay channel. There are, however, problems with the use of STBs connected by wire to a public service telephone network cable socket. For example, providing this functionality increases the manufacturing costs of the STB. This is because of the need to provide a modem, cable and connectors. In addition, some homes do not have a socket sufficiently near the television. In such cases, a new socket must be installed at extra cost and inconvenience to the consumer. In addition, many consumers object to unsightly cables and will sometimes disconnect them.

The trend has been to make use of communications equipment more convenient by developing the applications so that the user has less to do. The hardware/software is sophisticated so that the user does not have to be. In interactive television systems the communications links have followed this route by using the dedicated modem in the set top box.

A further concern that many consumers have relates to privacy. There is a fear that a permanent link to the STB might be used to monitor user behaviour. In addition, there are concerns that the amount of time a permanent back-link is used without the knowledge of the consumer may be excessive, giving rise to high telephone costs and a high incidence of STB calls clashing with normal telephone calls. A further common concern amongst consumers is that once a STB back-link is established, there is limited scope to move the STB to another position in the home, primarily due to the additional cost and inconvenience of re-installing another telephone network socket. Likewise, there is limited scope to move a STB between sites where different forms of back-link network connection are available, e.g. moving a STB with cable modem back-link to a home where only an old analogue telephone socket is available.

A wire-based modem with a wireless modem link may overcome some of the problems mentioned above, but frequently it serves also to increase the STB and other materials cost.

Various aspects of the invention are defined in the independent claims. Some preferred features are defined in the dependent claims.

It has been recognised by the inventor that convenience for the user may be better addressed by utilising the installed base of communications equipment to fulfil other and/or more general communications functions at a location, than by the use of additional dedicated hardware.

According to one embodiment of the invention, there is provided an interactive television system for a television terminal comprising receiving means for receiving signals transmitted via a first transmission path, the system comprising: means for receiving a user response to information presented at the terminal; means operable to recognise the user and for generating a code indicative of the user response, and for generating instructions for a user to set up a second transmission path by which to relay the code to a transaction facility.

The first transmission path may, for example, be over a television broadcast network such as via a satellite, terrestrial or cable network. The method of signal transmission may be adapted for either analogue (e.g. PAL, SECAM, NTSC) or digital (e.g. Digital Video Broadcast (DVB)) in its various manifestations, such as -Satellite -S), -Terrestrial (-T) or -cable (-C) television networks. In the analogue television case, the preferred method of transmitting the signal is within one or more of the unused vertical blanking interval (VBI) lines of a TV channel. In the digital television case, the preferred method of transmitting the signal is as one or more packetised elementary data streams multiplexed together with other TV channels and services to form a data transport stream.

Thus, the invention enables a back-link functionality which involves the user in the set-up process—as opposed to seeking to eliminate the user from the process altogether. The convenience lies particularly in the use of a user's installed base, such as an existing telephone line, wireless pico-net (such as Bluetooth) etc., providing other communications duties.

The user instructions are conveniently presented to the user visually on a display forming part of the terminal. Alternatively, the instructions could be presented aurally, for example, by means of a speaker forming part of the terminal.

The code may be transmitted in part of the second transmission path as an acoustic signal. In this case, the second transmission path may include a telephone transmission system using, for example, a variable frequency modulation-based code, such as frequency shift keying (FSK) or dual tone multiple frequency (DTMF) code.

The code may be transmitted during a first leg of the second transmission path, from the terminal to a telephone handset, in the physical form of an acoustic signal propagated through air. The methods for encoding and modulating the code during the wireless leg of this path may include frequency and phase modulation schemes including FSK and DTMF and such standard methods (e.g. V.21, V.22, etc.) as have been popularly applied to electrical transmission over telephone circuits. So as to reduce bit error rates and increase data rates, these may include emission by the terminal of acoustic training pulses to enable equalisation of multiple transmission paths between sender and receiver such as originate from the room acoustics in which the terminal and telephone receiver are located.

Additionally, the terminal may relay the code by wireless radio or infra-red means to an intermediate device such as, for instance, may be housed within a hand-held television (or STB) remote control unit from whence the code may be propagated over a comparatively shorter distance (compared with the likely distance from TV to telephone) through air in an acoustic form to the telephone handset.

However, the second transmission path may be any other convenient means by which the return of information may be provided indicative of the code. For example, a non-acoustic transmission system could be used, such as wireless communication from the terminal to the telephone (e.g. using wireless transmission standards such as Bluetooth or IEEE 802.11b) or some combination thereof.

Alternatively, the terminal may display the code to the television screen for viewing by the user, who then manually keys it into the telephone or other transmission interface.

Preferably, the system includes means remote from the terminal arranged to receive the said code signal and to generate a reply to the code for the terminal. For example, the reply may be transmitted to the terminal via the first transmission path.

The second transmission path may include a portion through the air between the terminal and a user's telephone by which at least the code is transmitted from the terminal to the transaction facility which may be a remote service provider, a product vendor or the like and in respect of which a transaction of some sort is intended. This may be a financial transaction, but could equally well be an information transaction of another sort.

The signal may conveniently be generated and sent through the air within an acoustic bandwidth. However, the signal itself may be buried in another tone or message as a data tag or other retrievable device such that it is rendered subjectively inaudible to the user.

In one embodiment the code is user-generated at the telephone in response to a prompt from the terminal forming part of the generated instructions.

The code may include an identifier for identifying a location associated with or specified by the user. For example, this may be a virtual address or a physical site.

In another embodiment, means are provided for generating an acoustic tone that is operable to cause the telephone to dial a pre-determined telephone number.

Preferably, means are provided within the terminal for executing software provided in response from the service provider. Thus, while the response may be a basic file of passive data such as an HTML file, it could also include an executable file, such as an applet or a multimedia file. Generally, the response may advantageously comprise software constituting a refinement of the information presented at the terminal. In an advertising application the response may be a specific promotional item.

The second transmission path may be established over a standard public service telephone network (PSTN) or via a wireless telephone network such as a cellular or cordless telephone network or via a cable telephone network or via a satellite or MMDS return path or some combination thereof.

The present invention also extends to a computer program, preferably on a computer readable data carrier, for controlling communication between an interactive television system having a terminal, comprising transmission receiving means and a display, and a service provider, the computer program comprising instructions for: presenting interactively selectable information at the terminal; recognising a received viewer response as a request for the interactive selection of the information; and in response to the viewer response, causing a code to be generated for transmitting to a remote service provider via a second transmission path, the code being indicative of the user response, and generating on the display viewer instructions on setting up the second transmission path.

According to a still further aspect of the invention there is provided an interactive television system having a terminal comprising transmission receiving means, a television service management device programmed to provide an electronic programme guide (EPG) with a first level of functionality for user selection of services provided to the terminal, and means for transmitting data from the terminal to a remote service provider, the management device being loaded with a full EPG with a second level of functionality for user selection of services provided to the terminal, the service management device being responsive to a received command to upgrade the EPG by enabling the full EPG for use by the user.

According to another aspect of the present invention, there is provided an interactive television system having a television or TVPC or other such television terminal, the system comprising: means for presenting interactively selectable information at the television terminal; means for receiving a response to the presented information; means operable to recognise the received response as a request for the interactive selection of the information; and means responsive to the received response for generating an acoustic signal for transmitting to a remote service provider via an audio telephonic link, the acoustic signal being indicative of a user selection.

The system also preferably has a receiver for receiving a response from the service provider at the television terminal via a television broadcaster.

An advantage of this system is that information on a television screen can be selected by a viewer, a request for further information can be forwarded via an acoustic signal that is generated and sent down a telephone line and the subsequent response from the service provider can be transmitted to the television via a broadcaster. This avoids many of the problems associated with prior art systems.

Preferably, the response from the service provider is an acknowledgement of receipt of or response to the acoustic signal.

Means may be provided for displaying a response from the service provider, such as an acknowledgement or short message.

The telephone link may be over a public service telephone network (PSTN) including those using digital communications protocols (such as Integrated Services Digital Network (ISDN), Asymetric Digital Subscriber Line (ADSL), Very high rate Digital Subscriber Line (VDSL), Asynchronous Transfer Mode (ATM) and/or Internet Protocol (IP) to carry voice circuits or via a wireless telephone network such as a cellular or cordless telephone network, including Global System Mobile (GSM), Universal Mobile Telephony Services (UMTS) and Digital Enhanced Cordless Telecommunications (DECT).

According to another aspect of the present invention, there is provided a method of communication between an interactive television system having a television or TVPC or other such television terminal and a service provider, the method comprising: presenting interactively selectable information at the television terminal; receiving a viewer response to the presented information at the television terminal; recognising the received viewer response as a request for the interactive selection of the information; and in response to the viewer response, generating an acoustic signal for transmitting to a remote service provider via an audio telephonic link, the acoustic signal being indicative of a user selection.

Preferably, the method further involves receiving a response from the service provider at the television terminal via a television broadcaster.

According to yet a further aspect of the present invention, there is provided a television signal that includes a response that is a product of the above method.

According to yet another aspect of the present invention, there is provided an interactive television system that is operable to communicate with a plurality of remote television terminals, the interactive television system comprising: means for receiving an acoustic telephonic signal over a telephone network in response to information presented at the television terminal; means for recognising the acoustic signal as being a response to the presentation of the information at the television terminal; means for interpreting either the signal or the incoming call to identify the television terminal; means for extracting user information relating to the information presented at the television terminal, and means for transmitting a response to the identified television terminal for presentation thereon via a television broadcaster.

According to still another aspect of the present invention, there is provided a method of communicating between a service provider and a plurality of remote television terminals, the method comprising: receiving an acoustic telephonic signal over a telephone network in response to information presented at the television terminal, together with an identifier for identifying a specific television terminal from which the response originated; recognising the acoustic signal as being a response to the presentation of the information at the television terminal; interpreting the signal to identify the television terminal and user information relating to the information presented at the television terminal, and transmitting a response to the identified television terminal for presentation thereon via a television broadcaster.

According to yet a further aspect of the present invention, there is provided a television signal that includes a response that is a product of the above method.

Various aspects of the present invention will now be described by way of example only and with reference to the following drawings, of which:

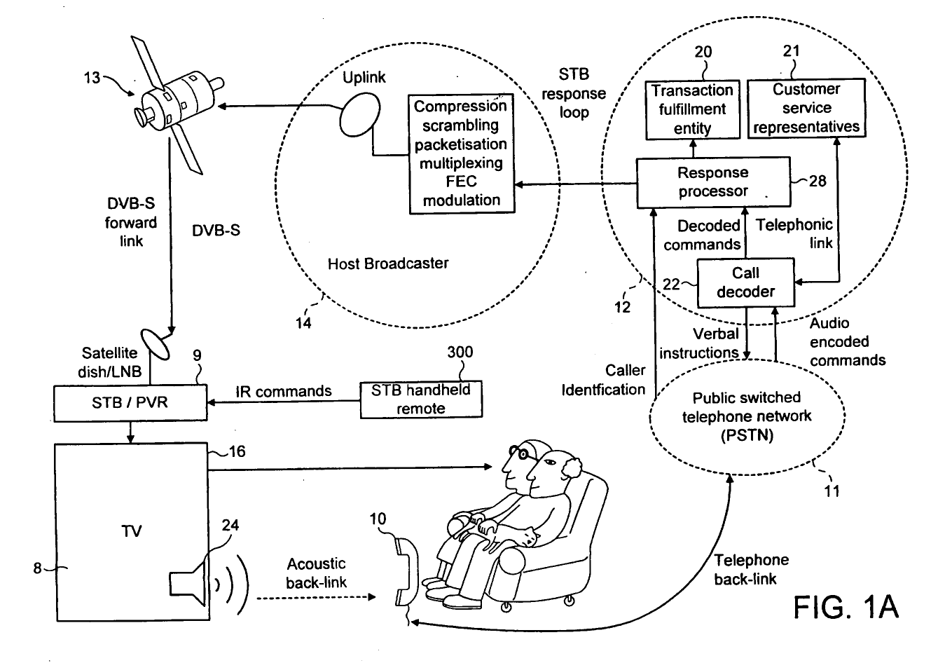

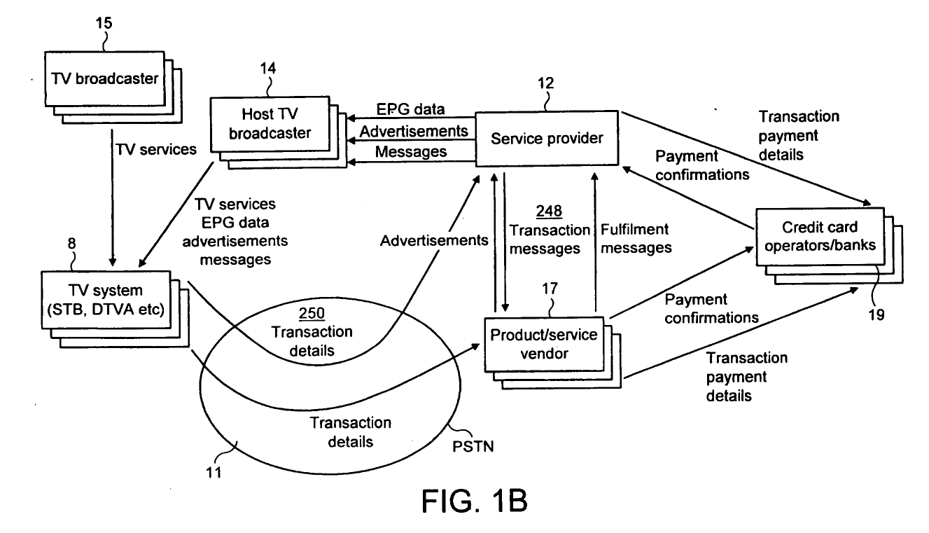

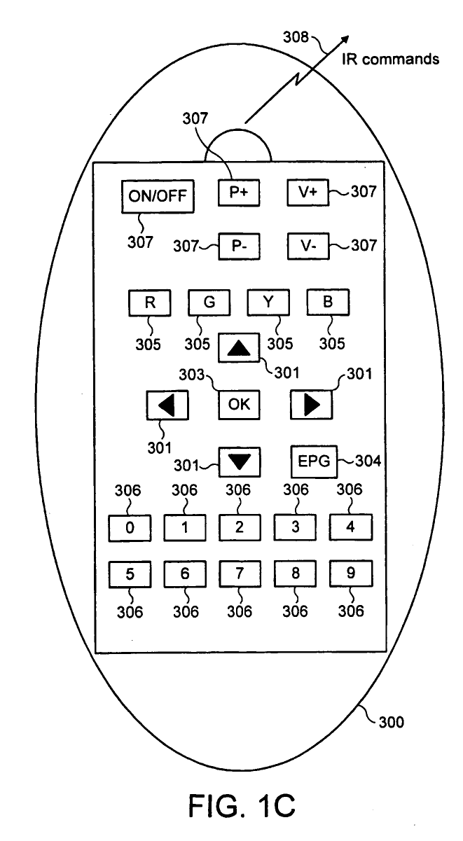

FIG. 1A is a schematic of the overall television system;

FIG. 1B is a schematic diagram of an overall system incorporating the present invention;

FIG. 1C is a schematic view of the remote control unit;

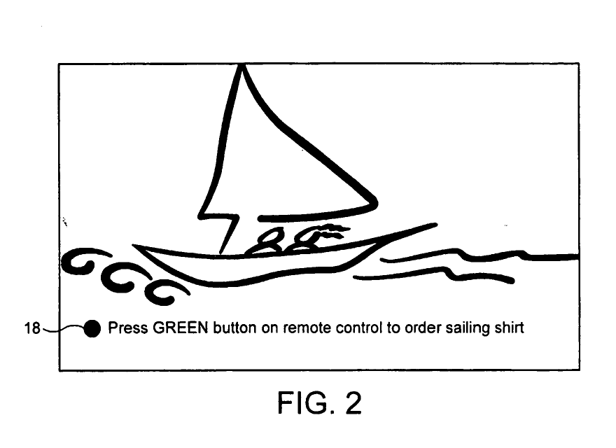

FIG. 2 is an example of a television screen on which an interactive prompt is displayed simultaneously with a currently viewed television programme;

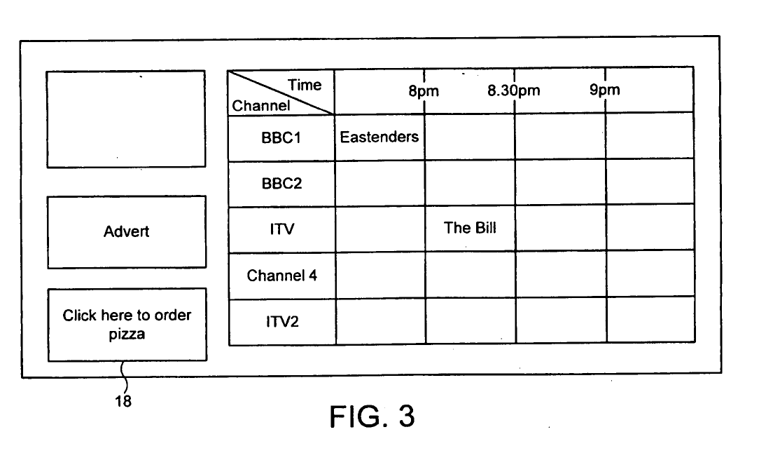

FIG. 3 is an example of a television screen on which an interactive prompt is displayed as part of an EPG;

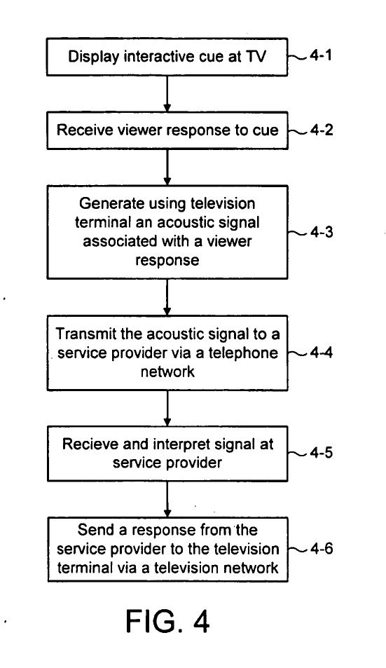

FIG. 4 is a flow diagram of a method for exchange of interactive messages between a television terminal and a service provider using the STB acoustic telephonic back-link method;

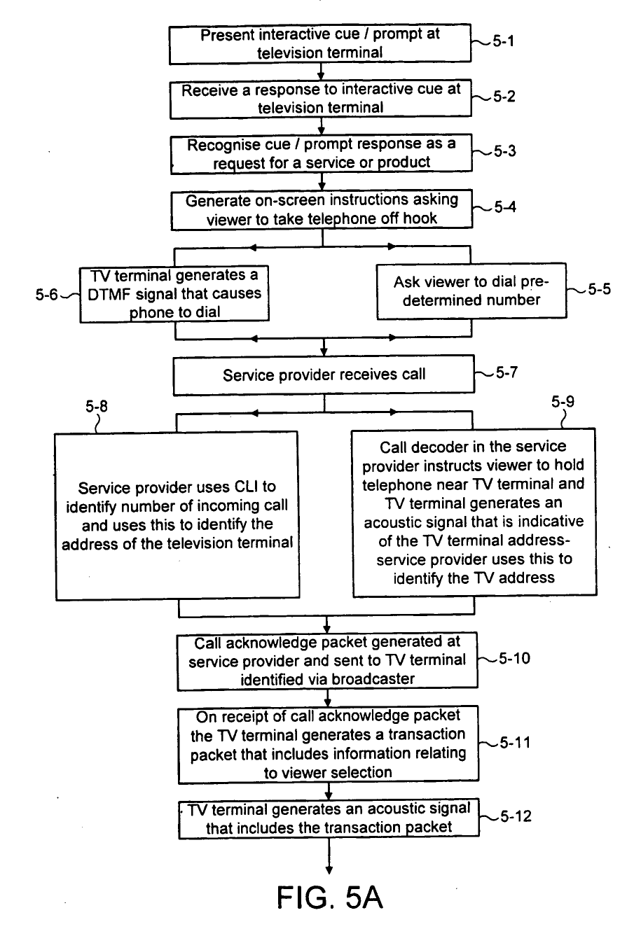

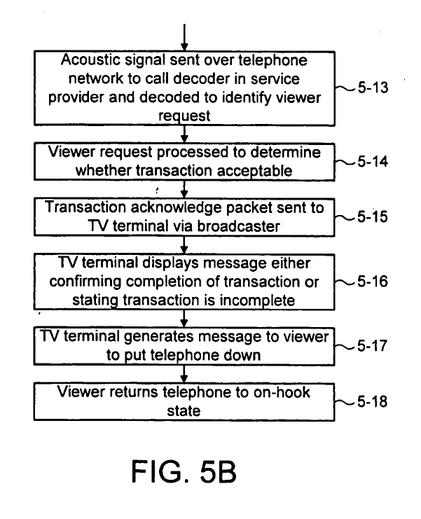

FIG. 5A and B is a flow diagram of the steps taken in a method for exchange of interactive messages between a television terminal and a service provider, which method uses a logical response, and

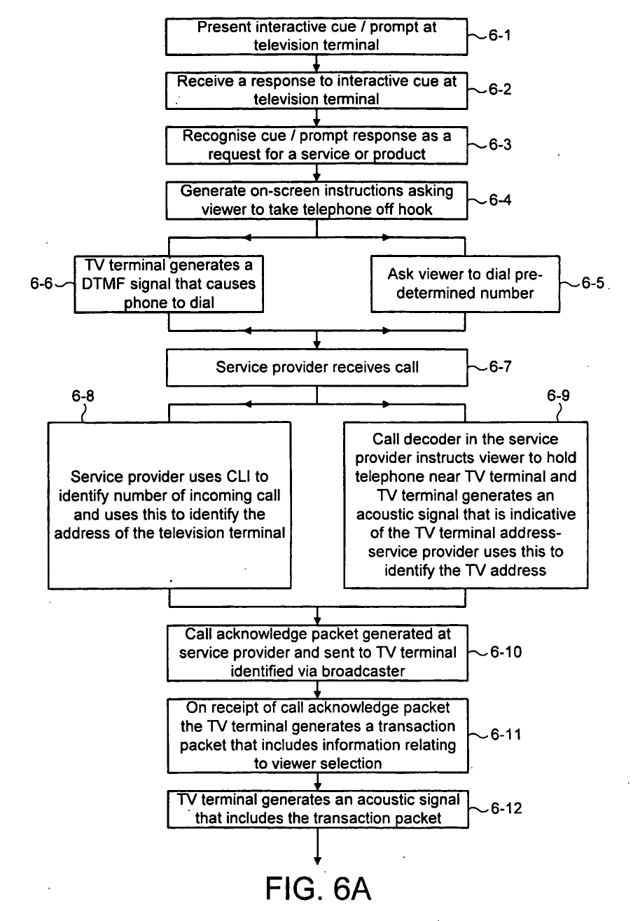

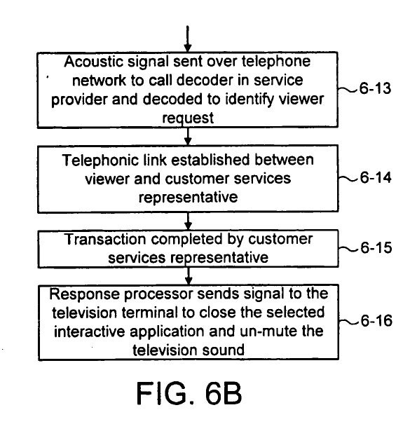

FIG. 6A and B is a flow diagram of the steps taken in a method for sending interactive messages between a television terminal and a service provider, which method uses a telephonic response;

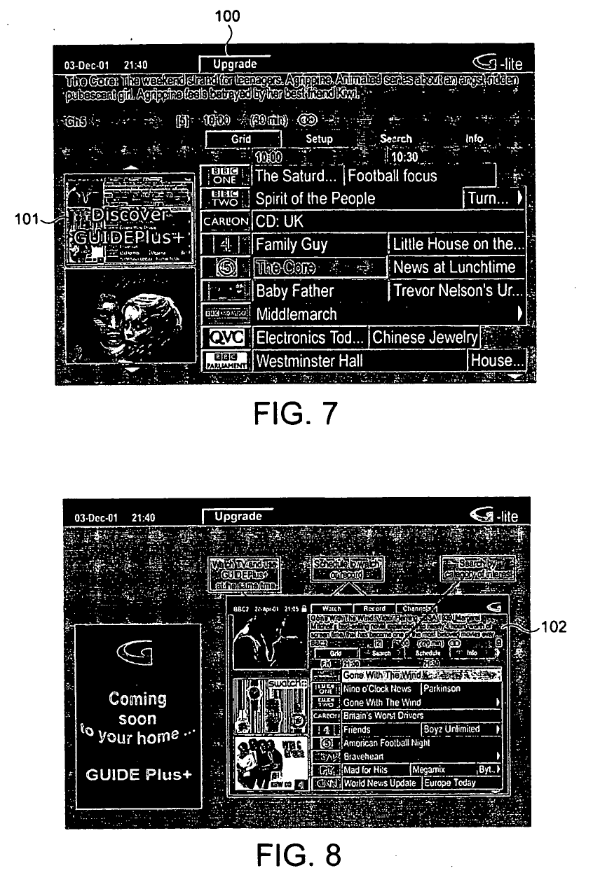

FIG. 7 is a screen display according to a basic EPG with on-screen “upgrade” action;

FIG. 8 is a screen display illustrating a U-Ad display whose panel was selected by a user, and which promotes an upgrade to the full EPG;

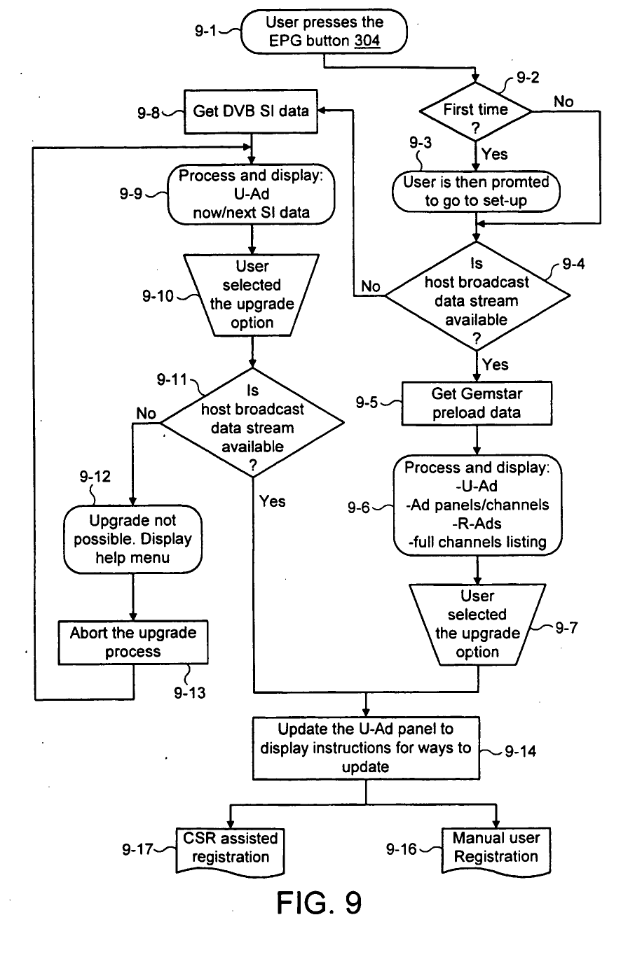

FIG. 9 is a flow chart of the overall process for upgrading from a Basic to a Full EPG;

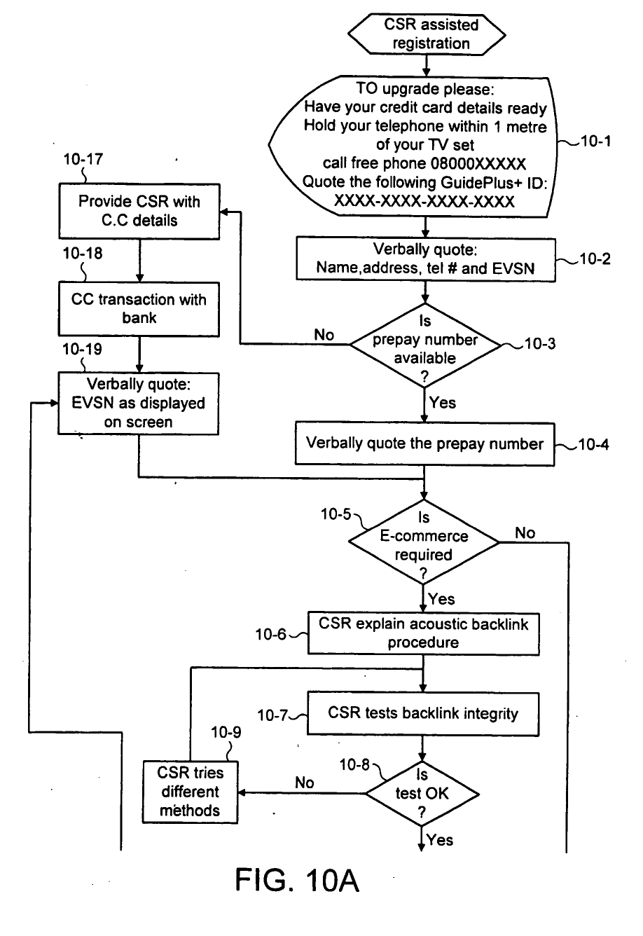

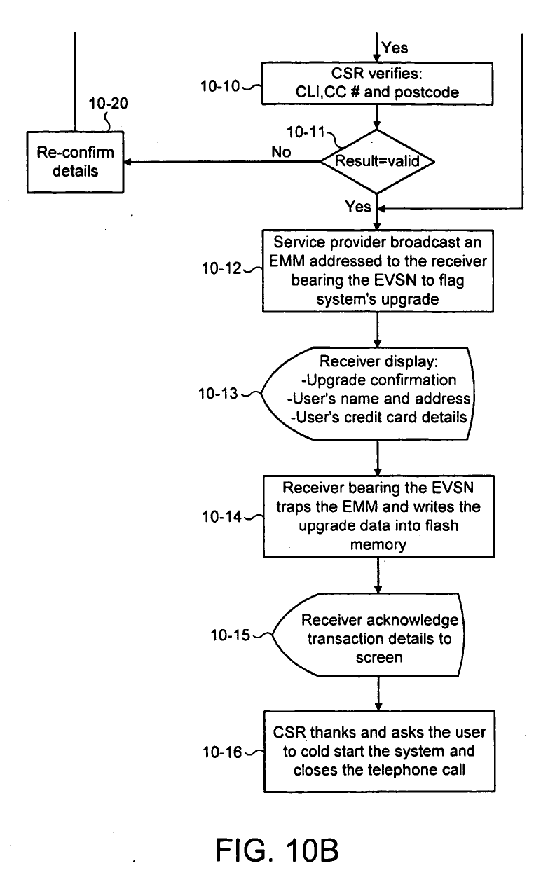

FIG. 10A and B is a flow chart of the process for customer service representative assisted registration during an EPG upgrade;

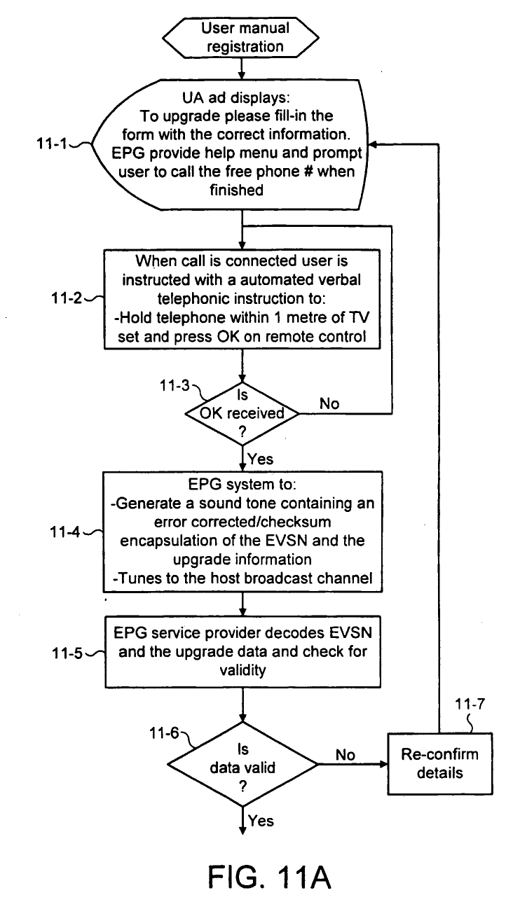

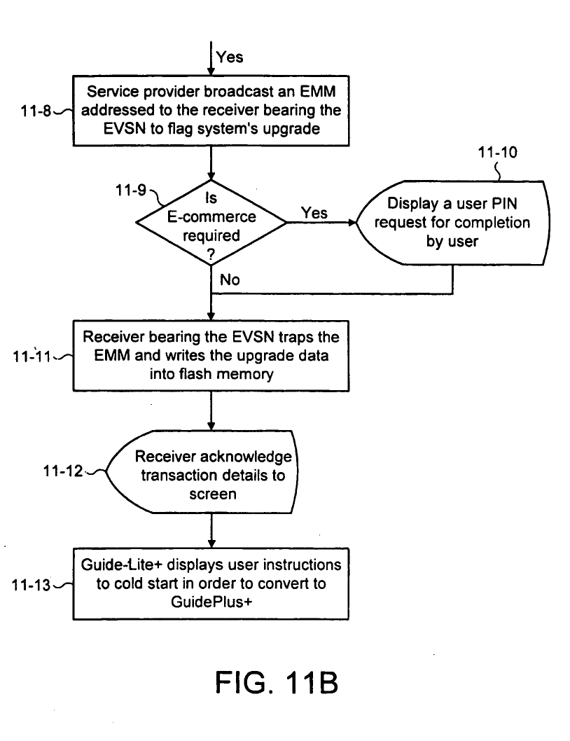

FIG. 11A and B is a flow chart of the process for a manual user registration during an EPG upgrade;

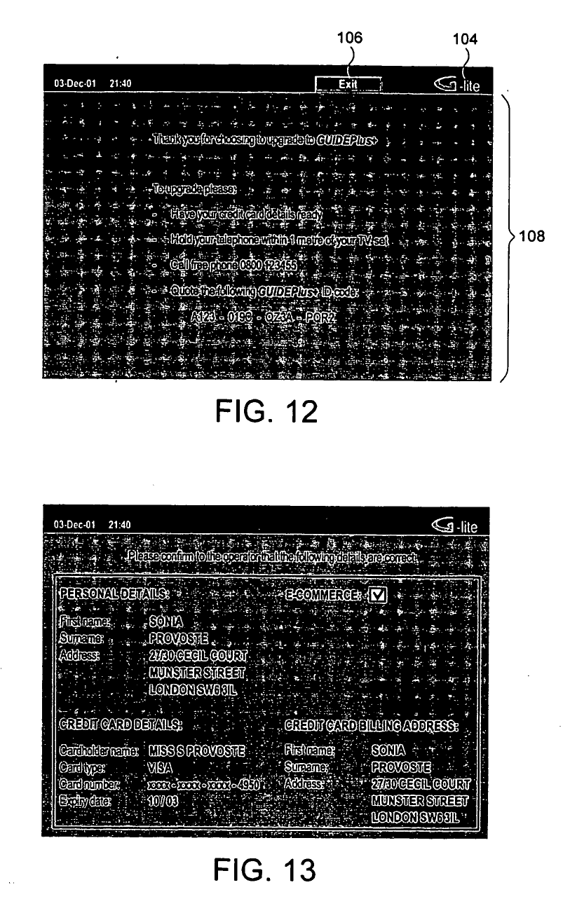

FIG. 12 is a screen display of an upgrade instruction screen;

FIG. 13 is a screen display of confirmation of personal details of the user for upgrading the EPG;

FIG. 14 is a screen display of a PIN entry;

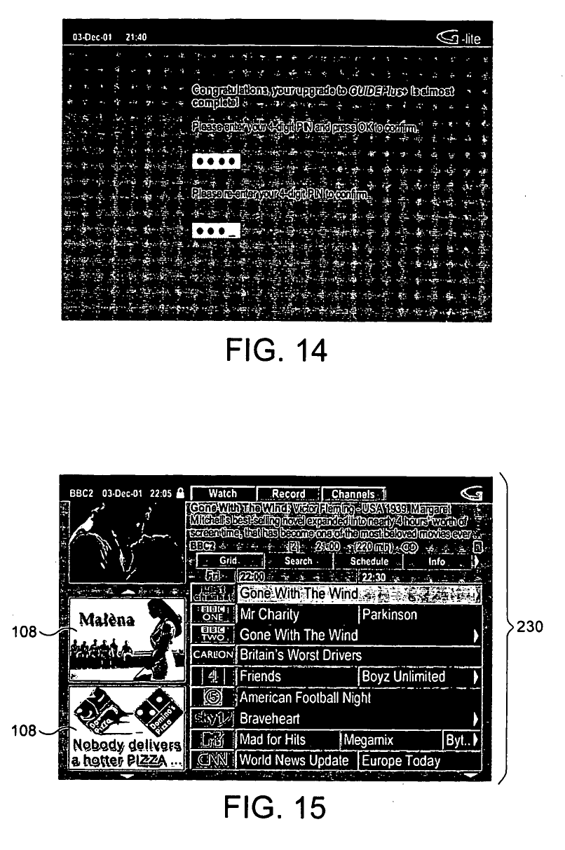

FIG. 15 is the entry screen display for a full EPG;

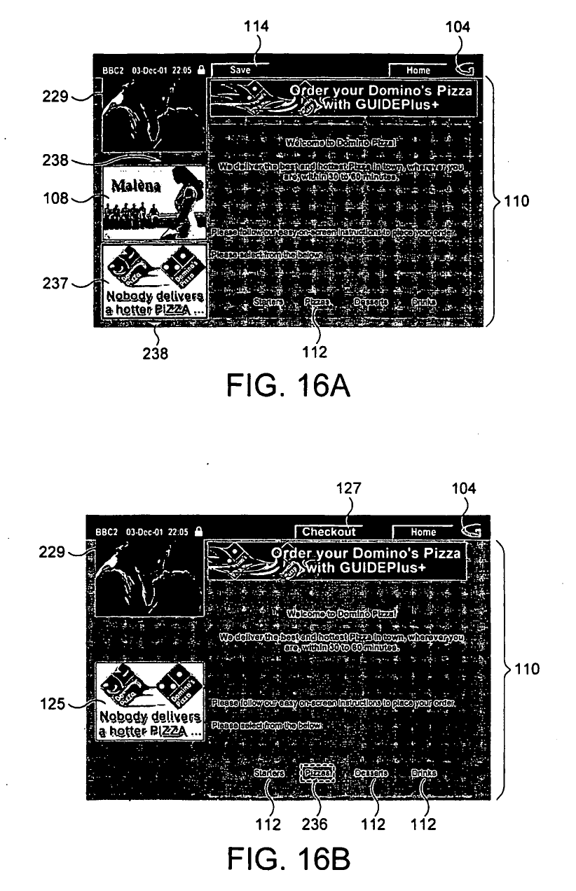

FIG. 16A is a screen display with an ad panel highlighted;

FIG. 16B is a green display with the ad panel selected;

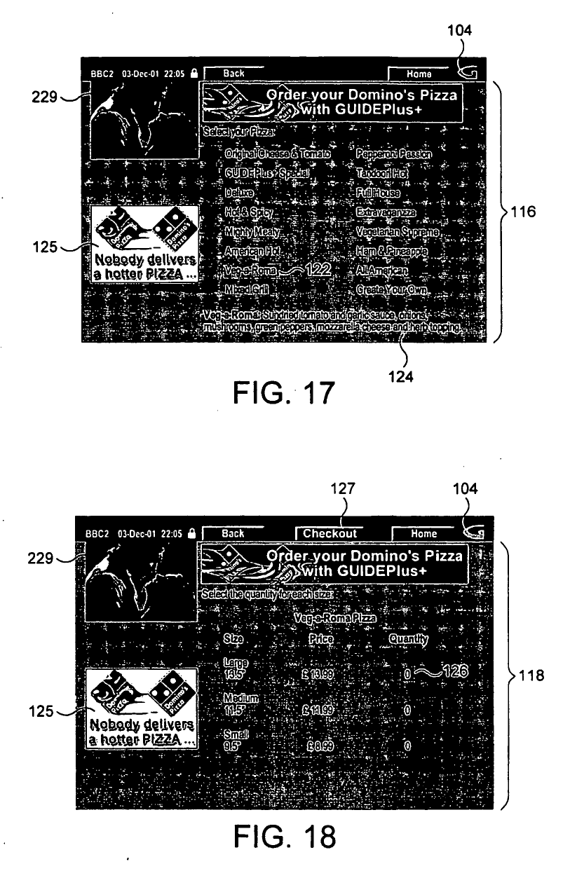

FIG. 17 is a screen display of an interstitial selection page;

FIG. 18 is a screen display of goods/service order entry page;

FIG. 19 is a screen display of an order summary;

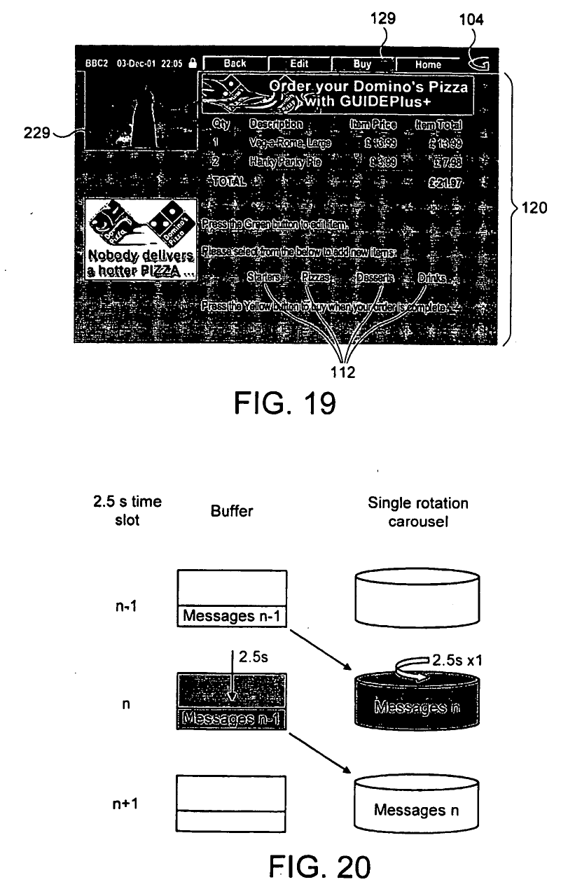

FIG. 20 is a schematic diagram of the message carousels employed within the Response Processor to successively buffer and broadcast messages to multiply addressed television systems;

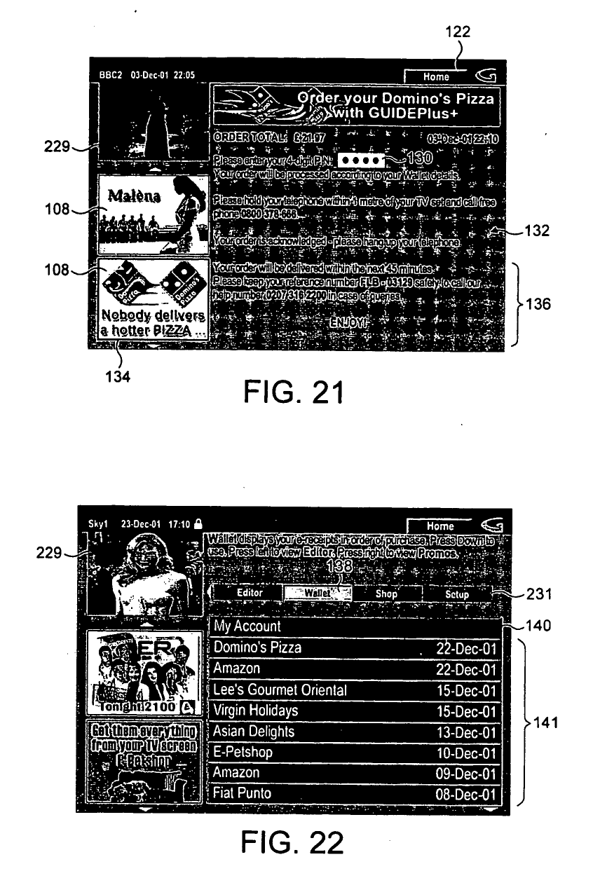

FIG. 21 is a screen display of instructions in response to a user selecting a “buy” action in response to an response enabled or transaction enabled advertisement where an acoustic back-link is used;

FIG. 22 is a screen display of entry into the display associated with the wallet feature in the full EPG;

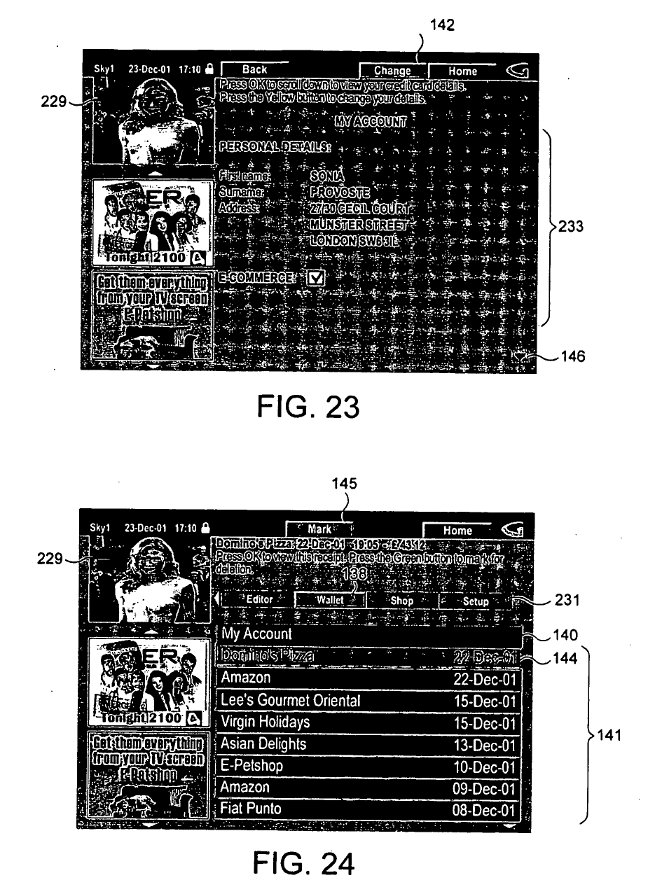

FIG. 23 is a screen display of user account details accessed through the wallet feature;

FIG. 24 is a screen display within the wallet feature of a list of titles of e-receipts associated with past user transactions;

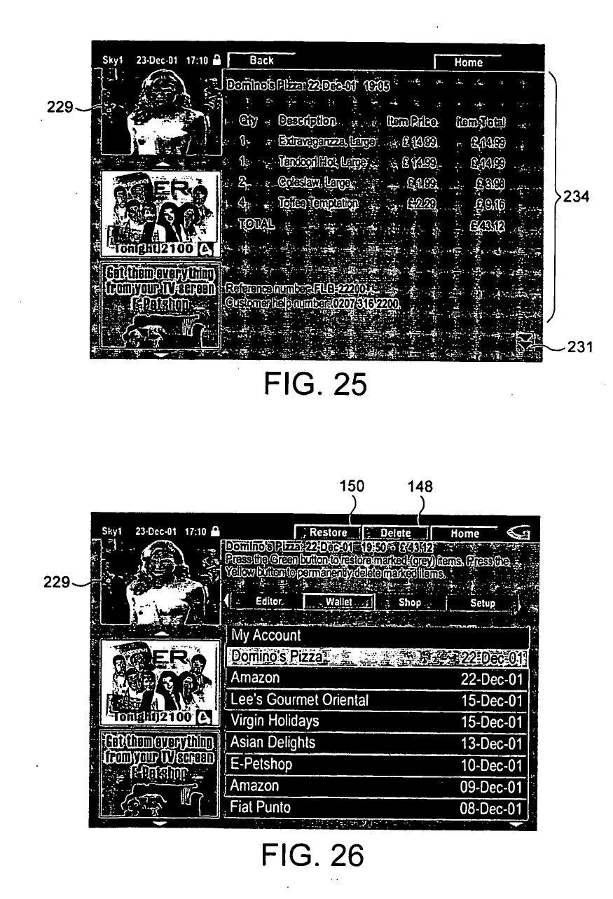

FIG. 25 is a screen display within the wallet feature of order information contained within an e-receipt;

FIG. 26 is a screen display of an e-receipt list within the wallet feature where a user has marked an e-receipt for deletion;

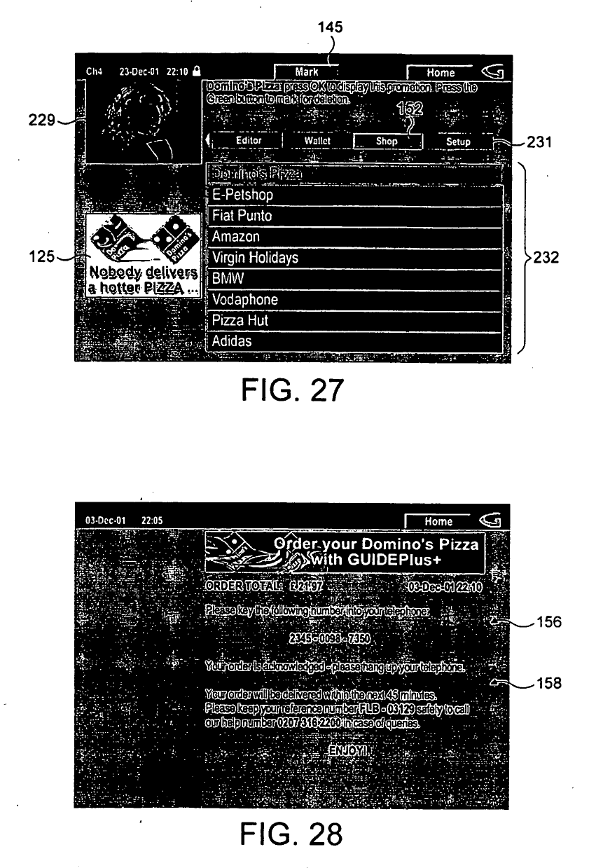

FIG. 27 is a screen display of user saved ad panels within the shop feature in the full EPG;

FIG. 28 is a screen display of instructions in response to a user selecting a “buy” action in response to an response enabled or transaction enabled advertisement where an Order Encoding (OE) back-link is used;

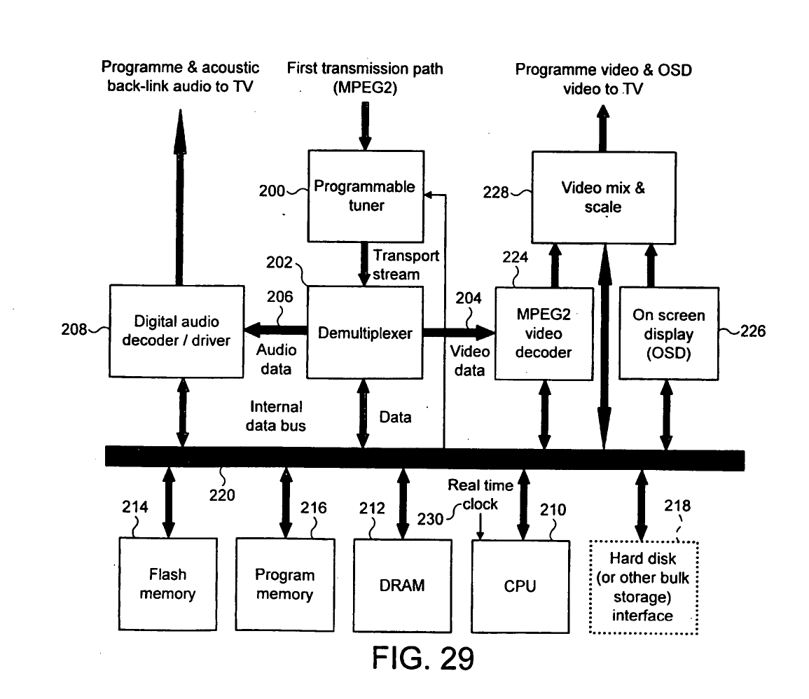

FIG. 29 is a schematic diagram of an STB television receiver that runs the basic and full EPG system and applications;

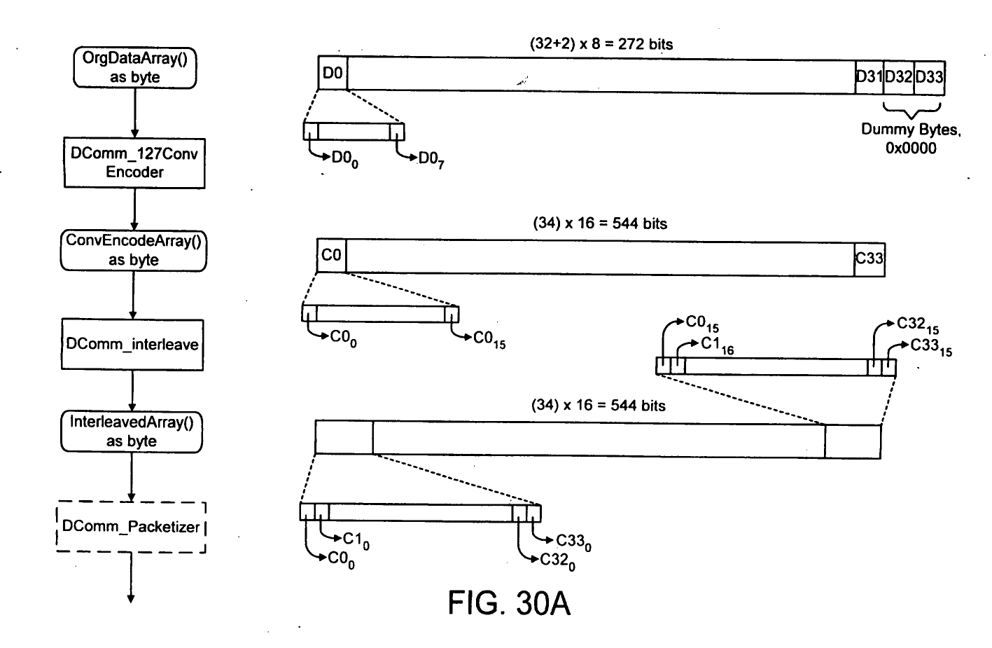

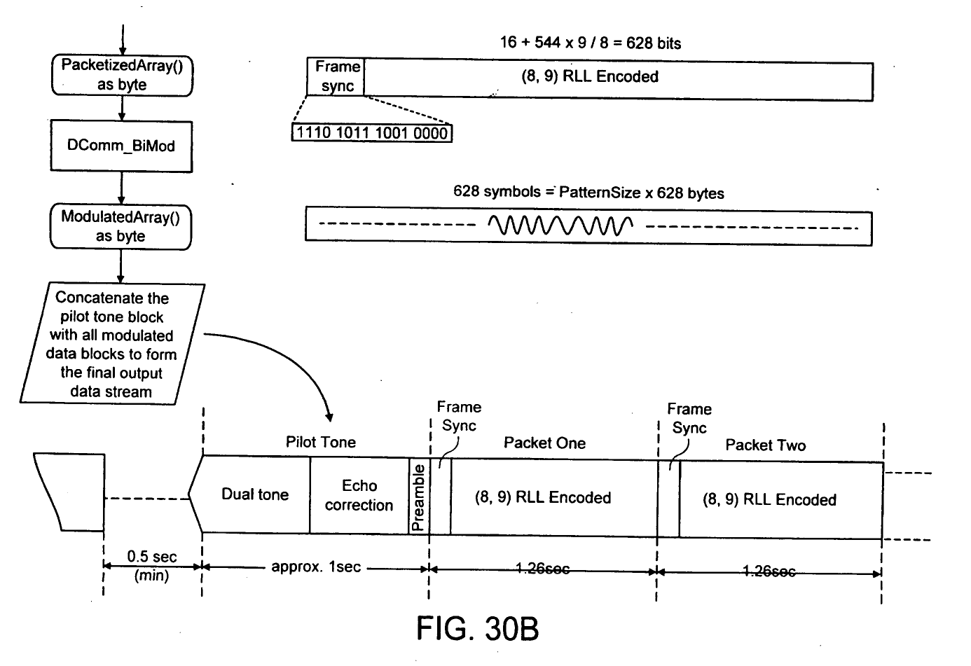

FIG. 30A and B is a diagram of the acoustic back-link data flow and format in the transmission side (from STB via TV loudspeakers); and

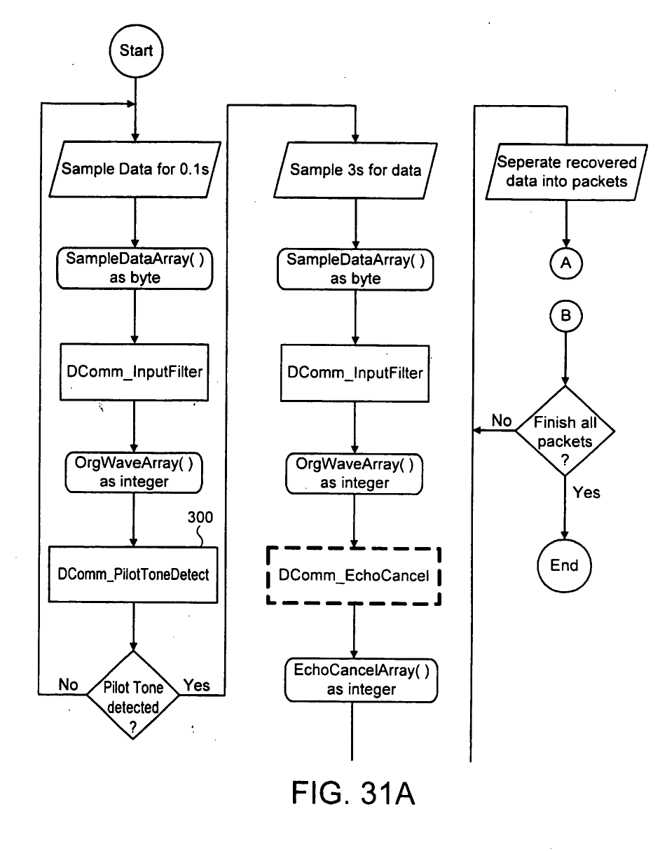

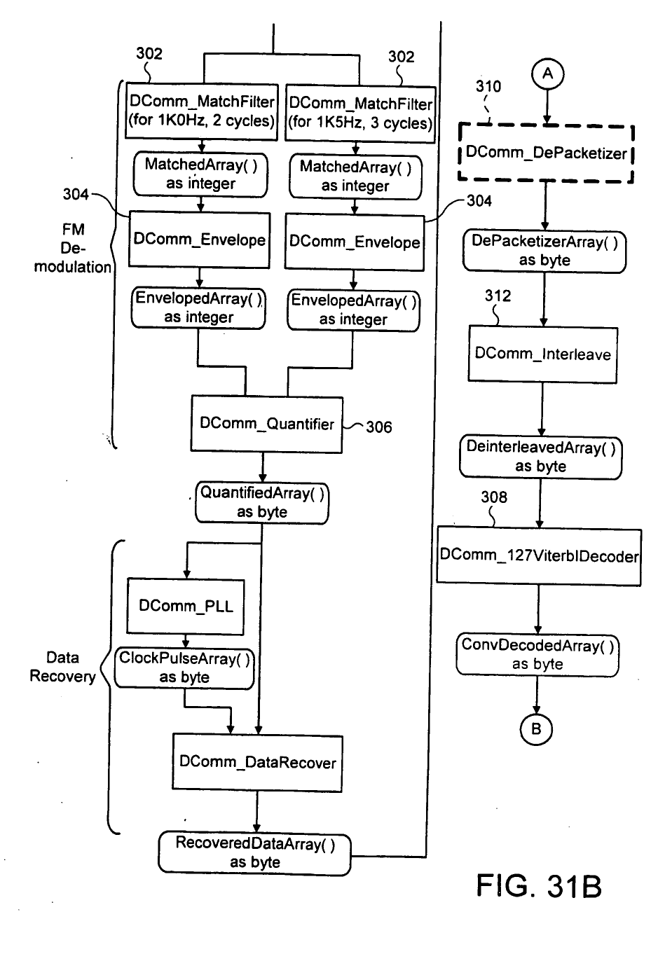

FIG. 31A and B is a diagram of the acoustic back-link data flow in the receiving side (Call Decoder in Service Provider).

FIG. 1A shows an addressable television receiver, e.g. a television (“TV”) system 8 with an addressable STB or personal video recorder (PVR) 9; a telephone 10 that is connected to a telephone network 11: a service provider 12 also connected to the telephone network 11, and a “host” broadcaster 14 which transmits to the STB over a conventional transmission path 13. The STB of FIG. 1 is a “satellite” STB, i.e. one containing a built-in satellite TV signal receiver. It will be understood, however, that any other addressable STB could be used, for example a cable STB or a digital terrestrial STB. Thus, the transmission path to the STB can be by any medium and system suitable for the purpose.

FIG. 1B describes the system of FIG. 1A applied to several vendors placing interactive TV application and EPG advertisements (transaction enable advertisements or transaction response advertisements, as described later) and receiving orders in response to them from TV system users. The advertisement data are routed to the TV systems 8 via the service provider 12 and via one or more of the “host” TV broadcasters 14 and multiplexed in with other TV services before transmission. Additionally, the host broadcaster(s) transmit the interactive TV application and/or EPG data to the TV systems 8. Further, such data may refer to services such as TV programme schedules carried by other TV broadcasters 15. Transaction telephone calls arising from user responses to the advertisements are returned via the telephone network 11 to the service provider 12 which communicates with each vendor 17 to fulfil orders and with credit card operators and banks 19 to confirm and handle payment transactions. Alternatively, the TV systems may initiate transaction calls directly to the Vendors 17 which, in such cases, signal the TV systems 8 via the service provider 12 and host broadcasters 14 to confirm transactions.

Advertisement content is submitted to the EPG service provider 12 by the vendors 17, which content is then sent with EPG data, and transaction-related messages, by the service provider 12 to the host broadcaster 14 for downloading to the STB by the transmission path 13.

In the arrangement of FIG. 1A, the host broadcaster 14 transmits signals including instructions that allow interactive services, promotions and advertisements provided by the service provider 12 to be made available to viewers via the television receiver STB. The STB is controlled by the user via a wireless, user-operated handheld remote control unit 300 as illustrated in FIG. 1C. The buttons may include cursor buttons 301, an “OK” or “Select” button 303, an EPG function select/deselect button 304, “hot” or coloured coded buttons 305 for which actions are dynamically assigned via on-screen icons or labels, number keys 306, and other buttons 307 that may control television channel, sound level and other parameters. The control unit 300 contains a wireless (in this embodiment infra-red) transmitter of commands 308 that is responsive to which button on the control is pressed.

Included in the STB is a resident interactive application for interpreting signals from the broadcaster 14 and presenting on a television display screen 16 of the TV system interactive prompts that can be selected by a viewer. These prompts can be presented simultaneously with, and as an enhancement to, a currently viewed television programme, as shown in FIG. 2. Additionally or alternatively, the prompt 18 may be displayed by user selectable interactive television applications that are executed within the STB and displayed to the TV, such as, for example, an EPG application as shown in FIG. 3. Referring to the steps of the flow chart of FIG. 4, the interactive prompt 18 is displayed at step 4-1. The user can select by pressing a specific button on the handheld television remote control unit 300 (see FIG. 1C) which transmits commands via infra red emissions 308 at step 4-2. The user ,can respond to the interactive prompt 18 by pressing cursor buttons 301 to navigate a highlighted area or border to cover or include the prompt 18 and then press the “Select” button 303 or hot button 305 to activate an application and/or action associated with it. Alternatively, this button can be a pre-assigned digit button, such as button “1” or one of a number of dedicated interactive hot buttons 305 (e.g. a green button, as requested in FIG. 2).

The STB application is arranged to recognise receipt of a response to an interactive prompt 18 as being an interactive selection of a service or request for further information from the service provider and cause various actions to occur to set up a back-link to the service provider 12. In the present case, the TV system 8 uses the telephone 10 to provide an acoustic back-link return path via the telephone network 11.

At steps 4-3 and 4-4 the telephone 10 can be used to communicate details of a transaction entered by a user via the television 8: a so-called “logical response”.

The telephone 10 can also be used to establish a telephone conversation link between a user and an operative of a service provider or a product vendor selected by the user: a so-called “vocal” response. Thus, information is communicated from the viewer to the service provider 12 at step 4-5 using acoustic signals that are generated by the STB, played out loud using the television loudspeaker 24 and sent to the service provider 12 over the telephonic link (a so-called “STB acoustic back-link”). In either case, following initiation of a transaction, at step 4-6 information is then communicated from the service provider 12 to the viewer via an up-link to the television signal host broadcaster 14 and from there to the addressable television receiver 8 or the STB 9. In order to receive and interpret telephonic signals from a STB, the service provider 12 has a central response processor 28 that is connected to each of a transaction fulfilment entity 20 and a call decoder 22(see FIG. 1A). The transaction fulfilment entity 20 includes customer details and is able to fulfil various financial and other transaction functions such as implementing financial credit checks and verifying whether the ordered service or product is available. The call decoder 22 is adapted to determine whether an incoming call is on a network that supports call line identification. If it is, the number from which the call is made is determined and passed to the response processor 28. If the network does not support call line identification, the call decoder 22 is adapted to recognise this and the incoming call is passed to an automated dual tone multiple frequency (DTMF) input system, where the caller receives automated verbal instructions to either arrange the telephone handset relative to the television loudspeaker 24 to pick up the acoustically transmitted signals or to key in DTMF tones to identify the caller or STB.

Stored in a memory (not shown) that is associated with the response processor 28 are details of the user (customer), including his/her telephone number and additionally the unique address or electronic/version serial number of their television terminal and account number. Hence, when the user is identified, either using call line identification or by manual keyed information, a unique electronic/version serial number is determined. In this way, the service provider can communicate with the user by transmitting information directly to the television terminal over the television network, for example over the satellite television network as shown in FIG. 1A.

Both of the STB acoustic and vocal response processes occur during live interaction between the STB application and a user, and where communication of certain data back to the remote service provider 12 is required. Examples of applications that can be provided by the STB needing some form of a communication path back to the service provider 12 for user transaction include: (1) purchasing a pay-per-view movie entitlement; (2) requesting or changing a premium channel subscription entitlement; (3) purchasing one or more product items (e.g. a pizza, theatre tickets or music CDs) in response to an advertisement shown on the TV; (4) requesting further information in response to an advertisement shown on the TV; (5) responding to an interactive game, poll or TV programme; (6) placing a lottery, gaming or other betting transaction; or (7) claiming a reward, tokens or a voucher in response to a TV programme or advertisement.

The STB acoustic response process steps will now be described for the case where a user places an order through a transaction enabled advertisement (T-Ad) where it is possible for a user to interact with the advertisement and order items promoted within it. The steps are shown graphically in FIGS. 5A and B. First the interactive cue or prompt is displayed at steps 5-1. Using the STB remote control, the user selects a desired service or product displayed on the TV screen by the STB resident interactive application. This can be done, for example, by selecting the interactive prompt 18 that is displayed during display of a television programme, or during display of an interactive STB application, or by making an appropriate selection from a menu generated by the STB. Once the selection is received and recognised at steps 5-2 and 5-3, the STB application generates on screen user instructions at step 5-4 and causes the TV system tuner to tune to and de-multiplex the host broadcaster's data stream carried within its TV signal. It mutes the TV sound and displays on-screen instructions advising the user to (a) reach for a standard, cordless or mobile telephone or other means for accessing the telephone network; (b) put the telephone in the off-hook state in reasonably close proximity to the TV loudspeaker 24, e.g. within 1-3 m; and optionally (c) confirm completion of steps (a) and (b) by pressing a designated key on the STB remote 300. The STB then displays at step 5-5 a telephone number corresponding to the desired service provider 12 on screen for the user to dial manually on the telephone keypad. Alternatively at step 5-6, the STB plays out via the television loudspeaker 24 a DTMF tone dial sequence that corresponds to the telephone number of the service provider 12. The sequence is picked up by the telephone handset mouthpiece and is used to dial the service provider number.

If call line identification is implemented on the telephone network and the STB is configured in its set-up mode to use it then, upon receiving an incoming call at step 5-7, the response processor 28 at the service provider 12, immediately looks up via call line identification the user's telephone number to determine the STB's electronic/version serial number at step 5-8.

Alternatively if a call line identification step is not to be performed, the STB application displays a message at step 5-9 requesting the user to listen to verbal instructions on the telephone from the call decoder 22 when the call is established. The instructions are typically: “Welcome to ABC, please place your telephone within X to Y metres of the TV, then press key Z on your STB remote”.

If key “Z” is pressed, the STB application plays out via the television loudspeaker 24 an audio identification message. This message does not need to be DTMF audio encoded but may be more aesthetically and/or more bandwidth efficiently coded using acoustic modulation (see later). The sound message is received at the telephone handset mouthpiece and transmitted to the call decoder 22 using the established call route. The call decoder 22 demodulates and decodes it to extract the STB identity.

The electronic/version serial number is notified to the response processor 28, which sends a “START_XMISSION” transmission commencement back-link control message (BCM) on to the broadcaster 14 at step 5-10 for inclusion in its TV broadcast data stream addressed to the user's ELECTRONIC/VERSION SERIAL NUMBER and interactive application. The STB operating system filters and downloads the BCM, passing it to the interactive application.

Back-link control messages are generated by the response processor 28 that may be simultaneously addressed to multiple electronic/version serial numbers in order to maximise bandwidth utilization. Back-link control messages control the back-link transmission method, communicate link status and flag link problems. The functions of the main back-link control messages are summarised below, where “An” refers to the electronic/version serial number for STB number “n“:

| BACK-LINK | |
|---|---|
| CONTROL MESSAGE | |
| (BCM) | DESCRIPTION |
| START_XMISSION, | Start transmissions from STB |
| A1, A2 . . . An. | addresses A1, A2 . . . An |
| BACKLINK_FORMAT | Set back-link transmission format to |
| Method, A1, A2 . . . An | Method in STB addresses A1, A2 . . . |
| | An. Method contains necessary |
| | parameters (such as TV volume, bit |
| | rate, modulation technique, error |
| | correction, framing) to fully define |
| | operating mode. |
| NO_DATA, A1, A2 . . . An | No data was received from STB |
| | addresses A1, A2 . . . An |
| CORRUPTED, A1, A2 . . . An | Could not recover data from STB |
| | addresses A1, A2 . . . An |
| ABORT, A1, A2 . . . An | Abort transmission from STB |
| | addresses A1, A2 . . . An |
| XMISSION_OK, A1, | Confirmation of valid transmission |
| A2 . . . An | for STB address A1, A2 . . . An |
| HUNG_UP, A1, A2 . . . An | Callers with STB addresses |
| | A1, A2 . . . An have hung up. |

When the STB resident interactive application receives a START_XMISSION back-link control message, it constructs a “transaction” message at step 5-11 containing information relating to the one or more service or product items ordered. The detailed formats and ordering of identifiers within transaction messages are specific to the service or product vendor. Typically, a message contains multiple variable (e.g. 8 to 24 bit) word length binary fields that uniquely describe the particular item(s) and respective quantities to be ordered from the service provider 12. For example, a transaction message to a pizza supplier may include binary identifiers for “2”, “Large Pepperoni Special” “3” and “Medium Vanilla Milkshakes” or to a theatre ticket vendor, a message might include “Starlight Express”, “Matinee Performance” “30 May 2001”, “4” “Adult”, “8” and “Child”. A personal identification number (PIN), previously registered with the service provider and keyed in by the user in real-time in response to the application during order entry, may optionally be included within the transaction message. The transaction message may also include payment details such as the user's credit card number. Additionally a transaction check-sum may be included in the message. A description of the acoustic back-link data packet transmission format is provided later.

Once generated, the STB encodes the transaction message into a digital bit stream suitable for play out as an acoustic signal, typically of 2 to 5 seconds duration, via the television loudspeaker 24 at step 5-12.

Various methods of modulating and encoding the transaction message data into the acoustic signal can be performed. Typically, these employ publicly known encoding methods such as frequency or phase shift keying modulation, as are often applied to data modems. Additionally training sequences, such as pilot and echo correction tones may be added in the beginning of these acoustic signals to allow the call decoder 22 to eliminate the effects of the user's individual room acoustics, TV loudspeaker and telephone microphone characteristics.

The acoustic signal is received by the microphone in the user handset 10 at step 5-13 and re-transmitted over the telephone network to the call decoder 22 at the service provider 12, which demodulates the telephone signal to recover the transaction message. The service provider response processor 28 then immediately transmits one or more diagnosis or control back-link control messages back to the STB via the host broadcaster 14. “XMISSION_OK” is sent if the transaction message was received without data errors. “CORRUPTED” is sent if an error is found followed normally by either “START_XMISSION” to command the STB to resend the acoustic transmission.

The STB operating system and hardware is arranged to filter and download the back-link control messages addressed to its electronic/version serial number, passing the message tokens to the interactive application. If a received back-link control message is XMISSION_OK, indicating a satisfactory transmission, then the interactive application acknowledges to the user with: “Purchase details received, please wait . . . ” or similar.

Alternatively, if a transmission error occurred, the STB application obeys the back-link control messages addressed to it in order to rectify the cause of the error. It may be requested to repeat an acoustic back-link transmission, with the same or altered transmission parameters (e.g. loudspeaker 24 sound volume, symbol rate, modulation, error correction), or to switch to a different back-link transmission format entirely.

When a back-link transaction message is received without transmission error, the service provider response processor 28 parses the messages. If the message is grammatically valid, the response processor 28 normally attempts to verify in real time (see later for off-line fulfilment verification) with its fulfilment entity 20 that the transaction can be accepted (e.g. whether product in stock, payment details valid, credit limit not exceeded etc) at step 5-14. The fulfilment entity 20 verifies and acknowledges the order by returning a non-null transaction identifier to the response processor 28 which in turn broadcasts an EXECUTED transaction diagnostic message and the transaction identifier addressed to the STB interactive application at step 5-15.

On receiving the transaction identifier at step 5-16, the STB interactive application displays an on-screen confirmnation to the user that the order will be fulfilled. Additionally, the application may process the transaction identifier to create an e-receipt associated with the transaction and store it in non-volatile memory for later reference by a user via the “Wallet” feature (see later).

The transaction identifier may be an integer number. Alternatively, it may be any data structure that uniquely identifies and describes the transaction in more detail. For example: an order reference number, a text description, item descriptions, prices, taxes and tax rates paid, method of payment, time/date of transaction and telephone number or other contact details in case of query.

Transaction diagnostic messages are broadcast by the response processor 28 via the broadcaster 14 that describe the status of an order placed by the user. They may be simultaneously addressed to multiple STB electronic/version serial numbers to maximise bandwidth utilization. The main transaction diagnostic messages are described in the following table:

| TRANSACTION | |
|---|---|
| DIAGNOSTIC | |
| MESSAGE (TDM) | DESCRIPTION |
| EXECUTED A1: TID1, | Acknowledgement of receipt and execution of |
| A2: TID2 . . . An: TIDn | order with transaction identifier (TID). |
| CANNOT_EXECUTE_{—} | Order cannot be fulfilled due to non-user |
| REMOTE A1, | specific reasons (e.g. out of stock). Normally, |
| A2 . . . An | ad would display on-screen advice for user to |
| | call a free phone number for details. |
| CANNOT_EXECUTE_{—} | Order cannot be fulfilled for user specific |
| USER A1 [, A2 . . . An] | reasons (e.g. wrong/expired credit card |
| | number). Normally, ad would display on- |
| | screen advice for user to call a free phone |
| | number for details. |
| SPECIFIC Message A1 | Promotion format specific binary response (e.g. |
| [, A2 . . . An] | “Sorry, the Deep Dish Vesuvio Pizza is |
| | temporarily unavailable in your area. Please |
| | remove this item from your order and re- |
| | confirm by pressing Buy” and/or return of |
| | messaging tokens). |

In cases where a transaction cannot be accepted, the response processor 28 sends a “CANNOT_EXECUTE_REMOTE” in cases where the fault is related to the service provider, and “CANNOT_EXECUTE_USER” where the fault is user related.

To conserve bandwidth, minimal user transaction detail is broadcast. However, the response processor 28 may address the STB with an order-specific explanation using the SPECIFIC Message. In such cases, the Message is vendor-specific and may be simply an error number for processing by the interactive application. Alternatively, the Message may be a descriptive text message or executable applet providing an on-screen or audible explanation to the viewer of what went wrong and what to do next, e.g.: “We are sorry. The Red Socks are out of stock—but have you considered the Green Socks? To order these, press the Back button to recompose your order”.

The STB operating system and hardware filter download transaction diagnostic messages addressed to its electronic/version serial number, passing them to the interactive application. If the “EXECUTED transaction diagnostic message” is received, the STB application acknowledges completion of the transaction and generates a prompt that is displayed on the television screen, e.g.: “. . . Transaction completed, thank you. Details will be included in your next statement”.

The STB programmable application saves details of the transaction to non-volatile memory for later reference as an “e-receipt” via the “Wallet” feature (see later) or some other method. Transaction details preferably include the transaction identifier, descriptions, quantities, prices, currency of individual purchase items, sale tax, vendor name, time and date of transaction, method of payment, order reference number and telephone number in case of queries and the time when the e-receipt will be erased. Once execution of the transaction is acknowledged, the user is prompted at step 5-17 by a displayed instruction to place telephone 10 on-hook which, when the call decoder 22 verifies that the call is closed at step 5-18, causes the service provider 12 to send a “HUNG_UP” back-link control message to the STB application which causes the STB application to re-tune to the TV channel previously being viewed by the user immediately prior to selecting the “Buy” action and the sound level to be restored.

The above method involves several exchanges of information between the STB and the service provider 12, i.e. the initial call set-up, the sending of the acknowledgement message, the transfer of transaction details from the STB to the service provider and then the transmission of the messages confirming completion of the transaction. It will be appreciated, however, that the STB could be arranged to gather all details of the transaction, prior to asking the viewer to take the telephone 10 off hook. In this case, the transaction message could be sent as soon as there is an audio telephonic link between the user and the service provider 12 and processed in the service provider, without sending “START_XMISSION” or other messages, such as is illustrated in FIG. 4.

Transaction diagnostic messages may be downloaded off-line and processed by STBs while they are in standby. An “EXECUTED transaction diagnostic message” may be sent off-line by a service provider 12 hours or days after the user has placed the order. For example, a user may order a pair of tennis shoes at 9 μm on a Friday night, but the order is not confirmed until the relevant “EXECUTED transaction diagnostic message” is received at the user's STB several hours later when the host broadcaster 14 transmits a periodic, routine download of data for, say, storage by an EPG application. The routine download may take place in an off-peak period, for example at 5 am the following Saturday morning. The user may later interrogate the STB to see confirmation of order details in an “e-receipt” feature—see “Wallet”, as described later.

The vocal response process steps will now be described. These are similar to those of the logical response, except in this case, the actual transaction is processed and finalised by a customer service representative. The communication links are nevertheless the same: messages are sent from the viewer to the service provider 12 by causing the STB to generate acoustic signals that are played out using the loudspeaker 24 of the television 8. Data is transmitted over the PSTN telephone network 11 and messages are returned from the service provider 12 to the user's interactive application via the host broadcaster 14. The vocal response method is useful in that many product and service transactions are too difficult for a user to articulate via manipulation of a remote control and selection from on-screen menus. In such cases, it would be preferable for a user to talk with a customer service representative and be advised of what order items and options are available and appropriate to the user's needs. The vocal response method is useful from a customer service representative's perspective because it is unnecessary to preface each user conversation with questions about the user or details of the response enabled or transaction enabled advertisement to which the user is responding.

FIG. 6 sets out the steps of the vocal response method. As before the interactive cue or prompt is displayed at step 6-1. Using the STB remote control, the user selects a desired service or product displayed on the TV screen 16 by the STB resident interactive application. Once the selection is received at step 6-2 and recognised at step 6-3, the STB application generates on-screen instructions at step 6-4 and mutes the television 10 sound, tunes to and de-multiplexes the host broadcaster's 14 data signal. The on-screen instructions advise the user to (a) reach for a telephone handset; (b) put the handset in the off-hook state in the proximity of the TV loudspeaker; and optionally (c) confirm completion of steps (a) and (b) by pressing a designated key on the STB remote. The STB then displays a telephone number corresponding to the desired service provider on screen for the user to dial manually on the telephone keypad at step 6-5. Alternatively, the STB plays out via the TV loudspeaker 24 a DTMF tone digit sequence at step 6-6 that corresponds to the telephone number of the service provider. If call line identification is implemented on the telephone network, the call decoder 22 receives and identifies the user's telephone number at step 6-7 and the response processor 28 uses the telephone number to look up the STB's electronic/version serial number. Alternatively, the STB application plays out via the TV loudspeaker 24 an acoustic identification message, which can be used to identify the electronic/version serial number.

When the electronic/version serial number is identified, the response processor 28 generates and sends immediately a “START_XMISSION” message onto the host broadcaster 14 for inclusion in the TV broadcast data stream that is addressed to the STB and interaction application. The STB operating system filters and downloads the message addressed to it, passing it to the interactive application. The STB application constructs a transaction message to appraise the customer service representative of the type of transaction or promotion. The STB then modulates and encodes the transaction message into an acoustic digital bit stream sequence and plays out the acoustic sequence via the television loudspeaker 24. This acoustic sequence is transmitted over the telephone network 11 to the call decoder 22, which recognises the transaction message as being intended for sending to the customer services entity 21 in the service provider 12. The customer services entity includes facilities for allowing the user to talk directly with a customer service representative. In this case the response processor 28 may parse the contents of the transaction message and address a message to the on-screen display 16 via the broadcaster 14 using the “SPECIFIC” message acknowledging the user's interest in a specific product or service, and asking to hold while a call is being put through to a customer service representative. For example, the following message may be transmitted to the STB and displayed: “Thank you for your interest in our South West Trains Weekend Discount Tickets—please hold on the telephone while we try to connect you to one of our sales staff . . . ”.

Steps 6-8 to 6-13 equate to the steps 5-8 to 5-13 of FIG. 5. The response processor 28 redirects the incoming call and establishes an audio telephonic link between the user and a customer service representative at step 6-14 to conclude the transaction personally at step 6-15. Either immediately, or when the call between the customer service representative and user is hung up, the response processor 28 returns “HUNG_UP” addressed to the user's STB application to close the selected application, re-tune to the previously viewed television channel and restore the TV sound at step 6-16.

In each of the above examples, once a telephonic link between the customer and the service provider is set up, command messages can be sent from the customer to the service provider to cause the television terminal to generate acoustic tones, and send those tones to the call decoder 22 in the service provider 12 over the telephone line. In some cases, however, the acoustic path between the customer and the television 10 may be subject to interference. To address this, the call decoder 22 may be adapted to recognise certain keystrokes on the telephone handset as being indicative of the selection of a particular service or option. The appropriate telephone keystrokes may be indicated on screen by the STB, for example: “Press “1” for a blue T-shirt; “2” for a red T-shirt . . . etc”.

Alternatively, the appropriate keystrokes may be recited to the customer over the telephone line using a pre-recorded audio message located at the call decoder. In either case, pressing a particular key on the telephone handset is recognised by the call decoder as being a specific customer selection.

In this embodiment communication from the service provider to the STB application is performed across a DVB MPEG-2 digital transport stream, where the messages are carried in a dedicated private data stream containing STB electronic/version serial numbers embedded within packet identifier (PID) headers.

For cases where an STB has mass data storage (such as an STB with personal video recorder (PVR) function), the STB may pre-load multiple audio-video clips from the host broadcaster 14. Each clip corresponds to user responses related to a particular product. For example, a clip may be a video of a presenter saying “Thank you for purchasing our Remington DEF Shaver!”. Said clips may include audio clips that may be combined together to form the code transmitted in the acoustic back-link response.

Additionally, there may be situations in which the audible transmission of the code data from the terminal to the telephone is considered objectionable in a relatively raw encoded form such as DTMF or frequency/phase shift keying. To address this the code may be buried as a data tag in, or be masked by, a more aesthetically acceptable audible sound track such as a musical jingle or a spoken sentence so as to render it inaudible. The signal processing methods for recovery of such tagged data buried within other signals use conventional techniques that will not be described in further detail here as it will be well-known to the skilled person.

Additionally, the identity of an audible sound track itself may be used to convey the code data. For example, the spoken sound “Thank you for purchasing the size 12 necklace” may, in itself, correspond to the order to which it refers. In such cases the code can be inferred in a variety of known ways, such as by matching the incoming sound from the terminal to the call decoder using numerical correlation techniques against the sounds for each possible code stored within the advertisements held at the Service Provider.

There are various advantages associated with the present invention. For example, the STB only has to be modified to include software for running and controlling the functionality of the system and does not have to be adapted to include, for example, a modem. This minimises the manufacturing costs of the STB. In addition, the system provides a means to establish an STB back-link in any room of any house and does not require wiring. Furthermore, because the STB is not constantly on-line, this helps reduce consumer privacy concerns.

Other connections between the STB and the public wide area network link to the service provider can be used as an alternative to the acoustic path described above. For example, the network could be accessed via the internet, a cable connection, GSM, microwave link or asymmetric digital subscriber line. Other local links that could be used include wireless data and telephone pico-nets, such as provided for in the public IEEE 802.11 and Bluetooth specifications or by proprietary wireless forms of home audio-video gateway networks such as provided by Digeo Inc.'s Moxi architecture.

In another embodiment, the invention can be used to enable enhanced functionality within the television system. For example, an EPG provided with a television system, including the STB, may be a “basic” form of EPG programmed into the STB and having limited EPG functionality. The same soft/firmware running the basic EPG may also comprise a full featured, but dormant, EPG stored within the STB. Thus, by loading the basic EPG and the dormant full EPG, the service provider is providing the option of an upgrade without the concomitant cost of sending or otherwise upgrading the instruction set in the STB. This may be preferable to a pre-paid fully featured EPG in cases where the receiving appliance is low price and the incremental bill of materials associated with accommodating the full EPG specification is low.

Upgrading from basic EPG to a full feature EPG is generally applicable to television receiving platforms including STBs, DVD-RW (recordable DVD players) and personal video recorders (PVRs) where there is sufficient forward addressable bandwidth to broadcast entitlement messages to activate the full EPG upgrade and to send related messages such as back-link control messages and transaction diagnostic messages that may be required to support other functionality on the same platform.

A typical differentiation between supported user features on a basic EPG and full EPG is as follows:

| Features | Basic EPG | Full EPG |
|---|---|---|
| TV programme | DVB SI-EIT “Now & | 7-8 days |
| listings coverage | next” only | |
| Picture in graphic | No | Yes |
| Record/watch | No | Yes |
| Search | No | Yes |
| G-Info | No | Yes |

Important commercial potential for both users and EPG service providers comes from the interactivity by which the user is able to communicate with vendors' advertising within the programme viewing experience.

Referring to FIG. 7, users may upgrade to the full EPG by navigating to and selecting a special “User Upgrade” (U-Ad) advertisement panel 101 in the basic EPG, or by pressing a hot-key (e.g. Red button of coloured “fastext” buttons 305 on remote control 300 in FIG. 1C) corresponding to the action (e.g. Red icon 100 labelled “Upgrade” in FIG. 7).

The Basic EPG may typically allocate 250 kbytes of flash memory within the STB for a U-Ad panel 101 that, when selected, causes display of an ad comprising an attractive multimedia demonstration and promotion of the full EPG 102. The minimised advertising panel 101 is selected by the user to provide a full screen illustration of the full EPG service as shown in FIG. 8. In FIG. 8, the minimised full EPG advertising panel is now expanded, providing an animated demonstration including a motion simulation of picture in guide (PIG), watch/record scheduling, highlighted programme summary and other features associated with a full featured EPG. Once upgraded to the full EPG, this memory space is reallocated for storage of content associated with the more memory-demanding full EPG services and features, such as 7 day ahead programme listings.

The following table sets out the typical differences between the advertising and transaction features available with the basic and full EPGs:

| Advertising/E- | | |
|---|---|---|
| commerce | Basic EPG | Full EPG |
| Upgrade Ad | From commencement of Host | No |
| (U-Ad): T-Ad | Broadcasts | |
| that specifically | | |
| promotes | | |
| upgrade to Full | | |
| EPG) | | |
| Display Only | From commencement of Host | Yes |
| Ad | Broadcasts | |
| panels/channels | | |
| Response | From commencement of Host | Yes |
| enabled | Broadcasts and completion by | |
| advertisements | user of setup details | |
| (R-Ads) | | |
| Transaction | No | From commencement of |
| enabled | | Host Broadcasts and |
| advertisements | | registration by user to |
| (T-Ads) | | enable. |

The advertising and targeting functions are available to the basic EPG from when the host data broadcasting services to the EPG population has commenced. Basic EPG users are invited to provide their details, such as postcode, during user set-up in order to respond to advertisements that permit non-monetary transaction responses (R-Ads). Examples of R-Ads include brochure requests, polls, applications, competitions and quizzes. R-Ads are similar to other transaction enabled advertisements (transaction enabled advertisements) except that they do not permit a monetary transaction. The various methods for responding to R-Ads are otherwise similar to transaction enabled advertisements, as described earlier.

Referring to FIG. 9, the main steps for user initiation of an upgrade from a Basic to a Full EPG are described in a flow chart. In response to a user request at step 9-1, a setup menu appears if the Basic EPG is being used for the first time (Step 9-2) to invite the user to enter user details such as postcode. The Basic EPG attempts periodically to verify whether there is an EPG data service (“Host Broadcast Data Stream”) available to support the Full EPG feature (Step 9-4) by attempting to download “preload” data (Step 9-5) that are broadcast at certain times throughout the day and night when the STB is in power standby mode or not in use. When a data service is available the EPG may, depending upon its setup configuration, process and display U-Ads and R-Ads carried in the preload broadcasts (Step 9-6).

If no data service was found at Step 9-4 then the EPG reverts in its Basic mode to the display of such public data (e.g. DVB SI-EIT “now” and “next” event description ) as may be available (9-8/9-9). The EPG attempts to detect the presence of an EPG data service (9-11) when a user selects the upgrade action 100 on the screen display of FIG. 7, or responds to the U-Ad panel 101 (Step 9-10). If an EPG data service is found then instructions are displayed on screen informing the user on how to register for and complete the upgrade process (9-14), otherwise the upgrade process is aborted (9-13) and a diagnostic message is displayed to screen (9-12) such as: “Sorry, GUIDEPlus+cannot receive the broadcast TV signal necessary for its upgrade. Please ensure that you can receive Channel XYZ or call 012345 for assistance”. Then the upgrade process aborts.

These upgrade steps (9-10) and (9-7) are followed by steps to complete the upgrade via either a customer service representative assisted registration process (9-17) illustrated in FIG. 10, or via a Manual User Registration process (9-16) illustrated in FIG. 11).

Referring to FIG. 10 and the steps for customer service representative registration of an EPG upgrade, the user is asked to follow the on-screen procedures as set out in the display screen of FIG. 12 (10-1). The user may follow the on-screen instructions 108 or quit the upgrade process via the exit action 106.

The customer service representative asks for the user's name, address, telephone details and electronic/version serial number as displayed to screen 108 (10-2). The electronic/version serial number is used later by the service provider to address messages to the EPG, STB or television terminal depending upon the system's method of implementation.

The customer service representative may also invite the user to volunteer a Prepay Number (10-3/10-4) if available as proof of payment. Typically the Prepay Number is a 12 digit number, broken into groups of 3 or 4 to assist readability, that is sold to a user in a retail store in a sealed envelope or scratch card (where the user rubs away an opaque top surface to reveal it). Upon disclosure by a user of a Prepay Number, the customer service representative verifies that it is valid and has not been previously used.

If the user does not volunteer a Prepay Number, the customer service representative requests credit card payment details from the user (10-17) and executes a payment (10-18).

Preferably the user's credit card details (or extracts thereof) are broadcast securely after encrypting them using a cryptographic algorithm that employs a pseudo-random key, K, generated within the STB and transmitted via the acoustic backlink to the Service Provider 12, as described below. The crypto-text of the user's details are downloaded to the user's EPG and decrypted against the same key, K, to recover the plain text details.

During the call, the customer service representative asks the user whether he/she is interested to register to respond to transaction enabled advertisements (i.e. to register for e-commerce) (10-5). If transaction enabled advertisement registration is requested:

1. The customer service representative asks the user to place the telephone 10 in proximity to the TV loudspeaker 24 (10-6) in order to set up the acoustic backlink;

2. The Service Provider broadcasts a “START_XMISSION” message addressed to the STB electronic/version serial number over the forward path;

3. The Basic EPG generates a packet comprising a pseudo-random key, K, and transmits the acoustic tone corresponding to it;

4. The Service Provider receives the sound tone via telephone 10 microphone, checks that the packet data is not corrupted to verify the acoustic back-link's integrity (10-7/10-8) and decodes the packet to recover K.

5. If the verification fails the customer service representative may broadcast a message causing the Basic EPG to alter its method of generating the sound tone (such as by varying the volume, symbol rate etc) (10-9) before trying again.

Additionally the customer service representative verifies (10-10) that:

1. the user's Caller Line Identifier (call line identification) matches the user's disclosed telephone number(s);

2. the credit card number is valid;

3. the postcode matches address.

If the user's transaction data are valid (10-11), the Service Provider broadcasts over the Host Broadcaster's transport stream messages addressed to the EPG bearing the electronic/version serial number to cause:

1. Upgrading from Basic to Full EPG (10-12), with confirmation to user being displayed on screen (28-15);

2. User's name and address details (10-13), to be displayed to screen (see FIG. 13) for verification to the customer service representative by the user that they are correct.

Finally, the registration details are flagged to screen (10-16), the customer service representative thanks the user and closes the telephone call (10-16).

Alternatively a user, rather than calling out his/her personal account details to a customer service representative, may manually fill-in the same registration information into forms directly on-screen using the remote control 300 or by selection of soft keyboard characters displayed on screen The manual process is described in FIG. 11.

Upon completion of the requested data, the user is instructed on-screen to dial a free phone number for the service provider (11-1). When the call is connected, the service provider 12 gives automated verbal telephonic instructions for the user to stand with the telephone 10 close to the TV speakers 24 and press the “OK” button 303 to send the user's details (11-2).

In response to the user pressing the “OK” button 303, the Basic EPG:

generates a sound tone containing an error corrected/checksum encapsulation of the electronic/version serial number plus the user registration data;

tunes to the transport stream used by the Host Broadcaster 14 and sets a PID (packet identifier) stream filter to download UA entitlement management messages addressed to its electronic/version serial number.

The Service Provider decodes the electronic/version serial number and registration data and verifies that both are valid (11-5). If so (11-6), the service provider broadcasts over the host broadcaster's transport stream an entitlement management message addressed to the EPG bearing the electronic/version serial number to flag the upgrade (11-8) to trigger enabling of the full EPG.

The receiver bearing the electronic/version serial number traps the entitlement management message and writes the upgrade data into flash memory in the STB (11-11) and acknowledges the transaction details to screen (11-12) so that the user is aware of successful upgrade.

The EPG requests the user for a PIN in cases where he/she has registered for monetary transaction advertisements (transaction enabled advertisements), as illustrated in FIG. 14.

Finally in both the customer service representative assisted and Manual cases, the EPG may display instructions for the user to cold start and reboot the system in order to enable the full EPG. Upon cold power re-start, the EPG permanently reverts to the full EPG feature state as shown in FIG. 15.

The full EPG allows the user to transact with response enabled and transaction enabled advertisements using the cursor keys 301 on the remote control 300 to move to focus upon, i.e. highlight, an advertisement panel 108, where the panel ‘in focus’ is given a border 237. When an advertisement is highlighted, the right side of the screen, previously showing programme listings, is given over to an expanded advertisement panel 110 as shown in FIG. 16A.

In the example shown in FIG. 16A, the advertisement 110 is for a service, more specifically a pizza delivery service. The user may now employ the remote control 300 to construct an order by navigating focus, to and selecting from among options 112. Other interstitial screens may be displayed when one of the categories of service option 112 (starters, pizzas, desserts, drinks) is selected to further describe the category selected (e.g. pizza). A red action key 114 labelled “save” appears in the top of the action bar 104 above the expanded advertisement panel when the advertisement panel is highlighted. Selecting the “save” action will be described later.

One of the main benefits of the full EPG is the interactive nature by which the user may transact while engaged in television related activities. The response enabled and transaction enabled advertisement panels with which the user may transact are of particular benefit where a user may continue to watch television via a picture-in-graphic (PIG) 229, wherein the television picture is displayed, at the same time as composing an order or requesting a brochure. A highlighted advertisement panel is identified, for example, by its border colour, and, upon pressing the “OK” button 303, the right-hand portion of the screen in a particular embodiment is replaced with the expanded panel associated with the highlighted panel. FIG. 16B shows how the panel in focus 237 when selected: it takes a vertically central position within the minimised region on the left-hand side of the screen 125 and scroll pointers 238 in the form of white triangular features in the previous EPG screen are removed, thus encouraging the user to remain with the advertising panel and not be distracted by panels which he/she has not selected. This is shown in FIGS. 16B to 19. The highlighting feature associated with the remote control is now used to select a link or order entry field within the expanded panel.

Thus, a user may compose an order within the expanded panel by navigating through the interstitial panels. FIG. 16B shows an instance of an interstitial expanded panel 110 that, through user selection of hypertext links displayed within, leads to:

Other interstitial expanded panels 116 (similar to that in FIG. 17)

Order entry expanded panels 118 (such as that in FIG. 18)

Order summary expanded panels 120 (such as that in FIG. 19)

In the pizza example illustrated, one main order entry option 236 (“pizzas”) is highlighted by default upon display of the first level expanded panel 110 and the user may press the cursor keys 301 to highlight a different option 112. When the user presses “OK” 303 to select for the highlighted option 236, the interstitial ad panel 110 is replaced by the order entry panel 116 of FIG. 17. A user navigates to, and selects, the link 122 corresponding to an item or item category (e.g. “American Hot”, “Veg-a-Roma” etc) of choice by, again, using the cursor keys 301 to move the yellow highlighting border and pressing the “OK” button 303 to select. A second, fixed, area within the same expanded panel shows descriptive notes 124 that are responsive to the option 122 depicted within the highlighted border.

Upon selection of an option 122, the user order entry panel 118 replaces the menu panel 116. Highlighting items 122, item categories 112 or order quantity entry fields 126 may cause descriptive information (e.g. pizza topping combinations) to be displayed by means of the descriptive notes 124 in a fixed area.

Thus, the user may press the “OK” button 303 to select an item selection expanded panel 118 relevant to the highlighted link as shown in FIG. 17. The order selection expanded panel 118 shown in FIG. 18 contains order entry fields for pizza sizes which a user may navigate between with cursor keys to highlight a field. The user may enter information into the highlighted order quantity field 126 by pressing numeric buttons 306 on the remote control 300 or by using it to highlight and select number keys from an on-screen “soft” keyboard (not shown). Finally, when a user has completed composition of order quantities desired, the user may proceed from order selection 118 to display of an order summary screen 120 by pressing “OK” or a remote control key corresponding to a hot key “Check Out” label 127 which is displayed within the action bar 104 at top of the screen as soon as one or more of the quantity fields 126 are set by the user to a non zero value.

FIG. 19 shows an order summary panel 120 in which the selected items are listed. Hot key labels in the action bar include a “Buy” 129 and an “Edit” action. As with the ad panel 110 in FIG. 16, the order summary panel includes selectable options 112 to assist the user to return to the relevant menu panels.

The context sensitive hot-keys displayed in the action bar 104 at the top of the screen, aid or simplify navigation. In the case of FIG. 19, the user may select the red “Back” action to step back out of the pizza order summary expanded panel 120 to the previous panel. Alternatively (not shown), the order summary may contain further hypertext links that point to other order, interstitial or summary expanded panels.

Most of the advertisements displayed by the EPG are broadcast by the host broadcaster for downloading to its host STB's non-volatile memory and, typically, preloaded at four scheduled times per day into the STB when it is in standby mode. Advertisements contain a template (hypertext and graphics content), static variables corresponding to the order entry fields associated with them and an applet (executable software to control user interaction with the advertisement and manipulation of order fields) to which memory is assigned within the STB.

An advertisement may be highlighted and displayed by a user several hours or even days after it has been downloaded and, hence, it is useful to provide a mechanism whereby an advertisement may be withdrawn or replaced with a successor in case it has expired. Response enabled and transaction enabled advertisements may contain completed or partially completed order fields and hence, to prevent overwriting of these fields, are not downloaded multiple times if one of the same identity (AD_ID) is already stored in memory. Before downloading a response enabled or transaction enabled advertisement, the EPG application checks to determine that one with the same AD_ID is not already stored in memory. If a response enabled or transaction enabled advertisement with the same AD_ID identifier is already stored, then the EPG omits the download. Consequently, response enabled and transaction enabled advertisements with fully or partially completed order fields may be stored indefinitely by users in the EPG via the “Shop” feature (see later).

A class of messages, known as promotion management messages, are broadcast via broadcaster 14 in order to manage the behaviour of advertisements as set out in the table below.

| Promotion Management | |
|---|---|
| Message (PMM) | Description |
| TEAR_DOWN | Tears down R-Ad or T-Ad AD_ID1 thru |
| AD_ID1 [, . . . | AD_IDn from storage. Broadcast during pre- |
| AD_Idn] | loads. |
| SUBSTITUTE | Download and substitute R-Ad or T-Ad |
| OLD_AD_ID1:NEW_{—} | OLD_AD_ID with NEW_AD_ID. Broadcast |
| AD_ID1 [, . . . | during pre-loads. |
| OLD_AD_Idn:NEW_{—} | |
| AD_Idn] | |
| SUSPEND AD_ID | Temporarily suspends ordering against R-Ad |
| [Proportion] | and T-Ad AD_IDs in a randomly seeded |
| [Wait] | Proportion (optional) of cases for a time |
| [Message] | [Wait] and displaying Message when the Buy |
| | action for AD_ID is selected. Broadcast in 5s |
| | carousel. |

According to expiration parameters that are included by the advertiser in each advertisement, an advertisement may have a “campaign” life of several days before it is withdrawn from display, or removed from the “Shop” feature if it has been saved. However, advertisements may later be explicitly erased from STB storage (including removal from display in “Shop”) at any time during their campaign life by including the promotion management message “TEAR_DOWN AD_ID” within a pre-load. For example, an advertisement may have expired since it was pre-loaded.

Users may want to save certain response enabled or transaction enabled advertisements to “Shop” that correspond to certain vendor services of special interest or use. For example, a user may choose to save the pizza transaction enabled advertisement for re-use. However it is foreseen that, at some point, the vendor may need to amend its menu or adjust prices for certain items. It is thus desirable to substitute a new response enabled or transaction enabled advertisement in place of an old one without user intervention. “SUBSTITUTE promotion management messages” are broadcast at the beginning of each preload of EPG data to flag to the EPG whether an “old” response enabled or transaction enabled advertisement stored using the “Shop” feature needs to be replaced by a “new” successor response enabled or transaction enabled advertisement to be broadcast for downloading later within the pre-load. If the EPG determines that a “SUBSTITUTE promotion management message” refers to a response enabled or transaction enabled advertisement that has been stored by the user using the “Shop”, then the relevant response enabled or transaction enabled advertisement is erased from memory and replaced by its new version.

Communication of response enabled or transaction enabled advertisement order information is by the back-link method as follows:

The user highlights, for example, the pizza transaction enabled advertisement and completes the order details according to the ad panel order selection of FIGS. 18 and 19, and then presses the “Buy” key. The EPG clears the picture-in-graphic (PIG), mutes the sound, and causes the STB to tune to and receive promotion management messages that are repetitively broadcast on a data “carousel” carried on the host broadcaster 14 multiplex. The location of the carousel (e.g. transport stream ID, proportional/integral/differential, etc) within the DVB network is determined by the EPG system during initial user installation.

A vendor may broadcast via broadcaster 14 a “SUSPEND promotion management message” to suspend ordering from a particular advertisement AD_ID during peak times such as when bandwidth server or fulfilment capacity is in danger of being exceeded. Furthermore, it is desirable to save a user from the inconvenience or making a telephone call to discover that a desired transaction cannot be executed.

“SUSPEND promotion management messages” are repetitively broadcast with a carousel rotation period of approximately 5 seconds for each response enabled or transaction enabled advertisement that is suspended. Optionally “SUSPEND” is accompanied with a binary object, “Message”, whose format and fields are specific to the advertisement to which it relates. Its purpose is to convey a message or workaround process to users when the advertisement they are attempting to order from is suspended.

For example, for the case of the pizza delivery service described earlier, the vendor may be so overwhelmed with orders at certain peak times that it becomes necessary to temporarily suspend ordering against all, or some proportion of, pizza transaction enabled advertisements. A user who selects the Buy action on a suspended transaction enabled advertisement might see, for example, a message similar to “Sorry, we cannot take your order at this time. Please try again in 30 minutes”.

Optionally, a “SUSPEND” message may carry a “Wait” time parameter, denoting the time in seconds before the “Buy” action may be selected again. Further, a “SUSPEND” message may carry an optional “Proportion” parameter prescribing a probability that each EPG will obey the “SUSPEND” message. If such a parameter is encountered, the EPG generates a pseudo random number between 0 and 1.0 where, if said number is less than Proportion, the “SUSPEND” message is obeyed—otherwise it is ignored. This method of suspending a controlled proportion of the ordering population is useful because it allows for a finer and more continuous adjustment to instantaneous order rates compared with simply suspending the whole transaction enabled advertisement population, in order to better match a vendor's peak order rate capacity.

During any space of a few seconds, a single message command of the same type (e.g. “START_XMISSION, EXECUTED” etc) may need to be transmitted by broadcaster 14 to the STB population, in relation to multiple transactions addressed to multiple electronic/version serial numbers. To avoid unnecessary retransmission of each message command for each transaction, and thereby to improve bandwidth utilisation, command parameters of the same type are buffered and re-ordered so that they are grouped together by the message command to which they apply. For example the message sequence: “START_{—XMISSION} 12345; HUNG_UP 54321; START_XMISSION 67890; HUNG_UP 09876;” is replaced with “START_XMISSION 12345, 67890; HUNG_UP 54321, 09876;”.

Bandwidth utilisation improves as the buffering time before re-ordering the message sequence is increased. However the buffering time is limited to within the maximum delay that is tolerable to users in a real-time interaction, typically around 5 seconds. FIG. 20 shows how broadcaster 14 divides the message re-ordering and broadcast processes into a continuous succession of time slots that are each equivalent to half the maximum 5s interaction delay. Promotion management messages are buffered during 2.5 second time slots. At the end of each time slot (say, n'th slot), the buffer is ordered and grouped by message type (considered to be instantaneous) and broadcast during the next (n+1) time slot as a single carousel rotation.

After the user has selected the response enabled or transaction enabled advertisement “Buy” action and after the EPG has verified that no matching promotion management message exists to cause it to be suspended (e.g. by not detecting a promotion management message on a broadcast carousel of 5 second periodicity after a 6 second timeout), the EPG system displays a help screen (FIG. 21) asking the user to key in the personal identification number (PIN) 130 using the remote control. If the PIN is invalid, the user is requested to re-enter the PIN. On successful entry of the PIN, the user is instructed to stand close to the television associated with the set top box and to dial the telephone number displayed on the panel. Optionally, a response enabled or transaction enabled advertisement may contain a field that causes the EPG to bypass promotion management message detection or perform it concurrently with user PIN entry and/or dialing.

When the call is connected, the television speaker 24 emits the acoustic back-link tone corresponding to the order details, as encoded by the system in the STB. The EPG supplements the display panel (FIG. 21) to confirm the order 132 and to remind the user to replace the handset. The system waits for receipt of a HUNG_UP message from the host broadcaster 14 before tuning back to the last TV channel, restoring the PIG 229 and sound, and ad panels 108 minimised, with the current response enabled or transaction enabled advertisement panel highlighted 134 (as shown in FIG. 21). The EPG displays order reference details 136 (e.g. vendor, billed amount, reference numbers, etc.) and saves these for later reference using the “Wallet” feature to be described below. The user then returns to the EPG display 230 by pressing the right cursor key 301 on the remote 300 or selecting the key corresponding to the “Home” hot action label 122 on the screen.

Referring to FIG. 22, “Wallet” is a sub-mode of operation within the system whereby user account details and e-receipts for transactions can be retrieved for viewing. The user enters the “Wallet” sub-mode from whatever previous sub-mode he/she was in by keying the arrow cursor buttons 301 on the remote control 300 to switch focus onto the mode cells on the horizontal menu bar 231 where it is then a matter of pressing the left or right arrow buttons 301 to move focus to the “Wallet” sub-mode cell.

The user can inspect and alter his/her account and contacts details by moving focus vertically down from the “Wallet” cell 138 to the “My Account” cell 140 beneath. In doing so, the “Wallet” sub-mode cell 138 remains differently highlighted compared to the other cells on the horizontal menu bar 231 to signify that the EPG is in “Wallet” mode.

A user may navigate to beneath the “My Account” cell 140 to focus on one of the “e-receipt” cells 141. E-receipts are details of individual orders and transactions a user has made in the past.

The user may press the “OK” button 303 to select the focussed “My Account” or e-receipt cell 140/141 to cause their details to be displayed in full. For example in FIG. 23, the result of selecting the “My Account” cell 140 causes the user's account details 233 to be displayed. E-receipts are positioned relative to the “Wallet” mode cell 138 in reverse order of their transaction dates such that the most recent transaction e-receipt is denoted by the e-receipt cell located in closest proximity to the “Wallet” mode cell 138. A user may have more e-receipts than can be displayed on one screen. In such cases, a user may scroll down using the down remote control arrow button 301, navigate to and select e-receipt cells 141 displayed on lower pages.

For the case where a user has selected “My Account”, he/she may alter account details (e.g. because of change of address or credit card or loss of PIN) by selecting the “change” action 142 on the action bar. This initiates a prompt for the user to call a customer service representative and essentially repeat the registration steps described in the process of upgrading to the full EPG described earlier.

An e-receipt is a record of a transaction that is created and stored automatically by the full EPG in the STB for a certain period from when an order is submitted. Frequent ordering may cause the maximum capacity for e-receipts storage to be reached. In such cases, e-receipts may be erased automatically on a first-in-first-out basis or according to individual erasure dates that were included in the response enabled or transaction enabled advertisements by the vendor 17 or the service provider 12. It is noted that there will be applications in which it is possible for users to contact a customer service representative for details of both erased and stored e-receipts. Summary details (such as vendor, date, etc.) for each stored e-receipt are displayed inlaid within the e-receipt cells 141. In the example of FIG. 24, a pizza order 144 of 22^{nd} December 2001 has been focused by the user and the corresponding details 234 are shown in the screen of FIG. 25 which appears in response to the user selecting the cell by pressing the “OK” button 301 on the remote control. Single arrow scroll markers 146 appear on the extreme right hand margin at top or bottom within each selected e-receipt page to allow the user to move to and select in order to view additional pages of information in cases where these exist. A double arrow scroll marker 231 appears at the top or bottom of an expanded e-receipt display to allow the user to move to and select, in order to view, the previous or next e-receipt, respectively.

Referring to FIG. 26, toggling the hot action icon “Mark” 145 in FIG. 20 causes the e-receipt cell in focus to cycle between being alternatively marked for deletion or restoration. E-receipts marked for deletion are coloured grey or otherwise represented differently to unmarked receipt cells. A “delete” hot action label 148 and ‘restore’ hot action label 150 appear when one or more e-receipts are marked for deletion. Pressing the hot button 305 associated with the “delete” action 148 or “restore” action 150 causes the marked e-receipt cells and their contents to be permanently deleted or restored, respectively.

The order and position in which EPG advertisement panels 108 are displayed may be according to a process which does not allow a user to manually effect redisplay of a particular advertisement. It is therefore desirable for a user to be able to save an advertisement for access at a later time. The “Shop” facility of this embodiment of the invention allows a user to save or bookmark a focused response enabled or transaction enabled advertisement by pressing a list key corresponding to a “Save” action label 114 as shown in FIG. 16.

A user may enter the “Shop” sub-mode by navigating focus along the horizontal menu bar 231 until the “Shop” sub-mode cell 152 is in focus. FIG. 27 shows how a user can then inspect and order from individual response enabled or transaction enabled advertisements by moving focus vertically up or down between cells 232 that correspond to each, responsive to which its corresponding advertisement panel 125 is displayed in the left margin. Each response enabled or transaction enabled advertisement cell 232 is inlaid with a label typically bearing the vendor's name and/or the name of the product(s) or product category on offer. Response enabled or transaction enabled advertisement cells are positioned relative to the “Shop” sub-mode cell in reverse order of when they were saved by the user such that the most recently saved response enabled or transaction enabled advertisement is denoted by the cell located in closest proximity to the “Shop” sub-mode cell. Preferably, response enabled or transaction enabled advertisement cells are rendered differently (e.g. different border, font pattern or background colours) so as to allow a user to distinguish between them at a glance.

A user may have saved more e-receipts than can be displayed on a screen and, in such cases, a user may scroll down using the down remote control arrow key to focus on ad cells 232 displayed on lower pages. Pressing “OK” 303 to select a cell causes the panel's first level expanded panel 110 to be displayed as shown in FIG. 16B. The highlight cursor in the Shop panel of FIG. 27 is positioned on a pre-selected link 236 or other link 112, wherefrom the user may compose or repeat an order as before. The values of order entry fields within a response enabled or transaction enabled advertisement persist after use so that repeat ordering of previously chosen items requires no further user interaction except to select the “Check Out” 127 and then “Buy” 129 actions. Additionally, one or more cells 232 can be highlighted for deletion or restoration as described earlier for e-receipts within “Wallet”.

As an alternative to the method of transmitting information via the acoustic back-link for a user to communicate order details, for example, the user may use the telephone equipment itself. The response processor 28 may determine after data errors from a previous back-link communication for a particular user that an alternative method is preferable and explicitly select this method for use during the same or future transactions by broadcasting the “BACKLINK_FORMAT back-link control message” addressed to a user's STB either in real-time or during a transaction or pre-load where the Method parameter is set to “Order Encoding”.

After composing an order and selecting the “Buy” action, the user follows on-screen instructions to dial a telephone number and then key a sequence of numeric digits (the order encoding number) when prompted to do so by the television display 16. The order encoding method uses the same communication system to the acoustic backlink method described in relation to FIG. 1 except that the user keys the back-link code via the numeric (0-9) keys on the telephone 10 keypad. In this case the audio back-link signal is generated inside the telephone as DTMF or pulse tones in response to the keys pressed. Also the call decoder 22 is a DTMF or pulse dial decoder.

Order encoding is preferable in cases where the acoustic back-link method is unreliable due to difficult room acoustics (e.g. strong echos in large rooms) or too high user-to-TV distances, or unacceptable levels of background room noise or distortion due to a particular construction of the television or telephone. User order encoding is suitable for response enabled and transaction enabled advertisement panels whose item and quantity permutations are not too numerous to be manually keyed as a number. The number, I, of product items that order encoding can accommodate is I=log_{q+1}(10^{N}), where N is the maximum number of numeric (0-9) keys that may be conveniently pressed, q, is the maximum order quantity per item. Eight key presses (N=8) is a practical limit and would permit an order menu comprising ten items (I=10) with a maximum order quantity of five for each.

An order encoding number, γ, is calculated as

$${\sum }_{j = 1}^{N} {q}_{j} ( {\prod }_{i = 0}^{j - 1} {\overline{q}}_{i} )$$

where N is the total number of different items offered, and qⱼ and \overline{q}ⱼ are the unit quantity ordered and maximum permitted unit order quantity of the j'th product respectively and q₀=1. The order quantities are easily recoverable from γ, where

$${q}_{j} = DIV [ MOD \{ γ , {\prod }_{i = 1}^{j} {\overline{q}}_{i} \} , {\prod }_{i = 1}^{j - 1} {\overline{q}}_{i} ] .$$

However other formulae may be used to generate and recover from γ.

Optionally, the formula to generate γ may additionally contain a promotion identifier q₀ which, during its campaign life, has a one-to-one correspondence with the response enabled or transaction enabled advertisement identifier (e.g. the AD_ID), and where \overline{q}₀ is the maximum number of possible promotions. Thus, γ is instead calculated as

$${\sum }_{j = 0}^{N} {q}_{j} ( {\prod }_{i = - 1}^{j - 1} {\overline{q}}_{i} )$$

where q₋₁=1. In which case qⱼ is recovered from γ as

$${q}_{j} = DIV [ MOD \{ γ , {\prod }_{i = 0}^{j} {\overline{q}}_{i} \} , {\prod }_{i = 0}^{j - 1} {\overline{q}}_{i} ]$$

The steps for buying using the order encoding method are as follows:

1) The user highlights and selects services/goods using the STB remote control 300 from a desired response enabled or transaction enabled advertisement panel displayed to the television screen by a resident, interactive STB application;

2) The user then interacts with the STB application to compose an order in the same manner to that described above for the acoustic backlink method as illustrated in FIGS. 16A through 19, assigning order quantities to certain product items;

3) The user selects the “Buy” action 129 to cause the order details to be communicated to the service provider;

4) The STB application removes the picture-in-graphic from the TV display (see FIG. 28), mutes the TV sound, tunes to the host broadcaster 14 and displays on-screen user instructions to:

a) Reach for a standard, cordless or mobile telephone;

b) Dial a displayed freephone telephone number on a telephone keypad. To minimise the number of 0-9 digits needed to express γ, there may be a one-to-one correspondence between the telephone number and each response enabled or transaction enabled advertisement.

The service provider's response processor 28 looks up the user's call line identification to determine the electronic/version serial number when a call is connected. It then looks up the response enabled or transaction enabled advertisement's identity, AD_ID, corresponding to the incoming line number. The response processor sends a “START_XMISSION” back-link control message via the host broadcaster 14 for inclusion in the TV broadcast data stream addressed to the user's STB electronic/version serial number.

The STB installed application calculates the order encoding number, γ, as a function of the ordered quantities for each item on the order menu. When “START_XMISSION” is received, the STB application displays instructions 156 for the user to key the order encoding number into the telephone keypad as shown in FIG. 28. Optionally, the STB application may display instead a check-summed version of the order encoding number for the user to key in so that an accidentally keyed incorrect number can be later detected. Optionally, the interactive application instructs the user to terminate the check-summed number with a hash or some other key.

The user keys in the order encoding number or its check-summed version on the telephone keypad. The service provider's 12 call decoder demodulates the telephone DTMF signal to recover the order encoding number, stripping the checksum and verifying whether it is valid. If so, the response processor returns “XMISSION_OK” to acknowledge that the order is successfully received without errors. The response process then decodes the order encoding number to recover the order quantities qⱼ and, preferably, verifies in real-time with the Transaction Fulfilment Entity 20 that the transaction can be accepted (for example, that the product is in stock, payment details are valid, the user's credit card is valid or credit limit is not exceeded, etc.) and returns an “EXECUTED” back-link control message addressed to the STB detailing that the transaction will be executed. Failing execution a message detailing the source of the error is sent and displayed.

In the event of a successful purchase the STB generates a screen display “Purchase Complete—Please hang up your telephone” or an equivalent 158, as shown in FIG. 28. The user replaces the telephone on-hook. When the response processor 28 detects that the user has hung up the telephone it transmits HUNG_UP back to the STB. Once HUNG_UP is received, the STB re-tunes to the last viewed TV channel, restores the sound and picture in graphic (PIG) display. Failing to receive HUNG_UP within a predetermined number of seconds causes the STB application to display a warning on the screen.

FIG. 29 shows the internal functional elements of the STB embodiment that runs the basic and full EPG system and applications. The STB receives and decodes MPEG2 digital TV transmissions from the first transmission path at a programmable tuner 200. A demultiplexer 202 separates video data 204 from audio data 206. The audio data 206 is passed to a digital audio decoder 208 which produces the programme audio and synthesises the sound required to operate the acoustic backlink of the second transmission path. The system also comprises a CPU 210 coupled to volatile (DRAM) memory 212, non-volatile (Flash) memory 214 and program memory 216. The DRAM memory 212 is used to contain temporary information not required after cycling the STB into and out of a standby or off state. The Flash memory 214 is used mainly to store preloaded data such as programme schedule listings, but it may also contain any information recovered from the first transmission path at anytime. Further the flash memory contains a unique electronic/version serial number that is burnt into a protected memory area during factory assembly. For example, information enabling the activation of the full EPG feature set can be received and stored in flash at anytime.

The program memory 216 contains the STB operating software. In the preferred embodiment, the program memory 216 also contains the EPG and acoustic back-link application software. However, both the EPG and acoustic back link application software may be received from a data broadcast on the incoming satellite or other first transmission path and subsequently stored to flash memory, DRAM or bulk storage (hard disk etc.) 218.

A bulk memory storage interface is used if the STB has personal video recorder (PVR) capabilities, and is typically an ATAPI or SCSI hard disk interface, but other popular bulk data storage interface standards may be implemented.

The programmable tuner 200 is connected to receive the satellite transmission through a conventional dish. However, the same STB tuner or additional tuners may be provided to receive also cable and/or terrestrial transmissions carrying an MPEG2 digital signal. By means of the internal data bus 220, the EPG application software instructs the tuner 200 to receive any MPEG2 transport stream or service present on the satellite input, including the data streams carrying the host broadcaster's transmissions.

The tuned transport stream 222 is applied to the de-multiplexer 202, where elementary audio, video and data streams can be extracted. Moreover, the de-multiplexer 202 contains multiple hardware proportionaVintegral/differential filters (not shown) which are capable of detecting messages carried in the host broadcaster's data streams that are addressed specifically to the STB according to its electronic/version serial number.

Video data streams are applied to an MPEG2 video decoder 224 from the de-multiplexer 202. The output of this decoder is then combined with the output of an on-screen-display (OSD) generator 226 to provide the video signal to the TV display device 16. The OSD generator 226 is responsible for displaying graphical elements of the EPG application, including the advertisement panels. The video mix and scale function device 228 scales the decoder video in order to present a reduced size live picture within the EPG display. This is the picture in graphic (PIG) display.

Audio data streams 206 extracted by the de-multiplexer 202 are applied to the digital audio decoder/driver 208. This digital signal processing function converts the digital audio stream into an analogue signal in order to apply it to the loudspeaker 24 within the TV (or TVPC) 8. It is within this functional element that the EPG application software running on the CPU 210 can mute the audio output or inject its own audio signal. When the acoustic back-link is operating, the digital signal processing CPU 210 generates the acoustic back-link signal by injecting the required DTMF, or according to some other modulation encoding scheme, signal into the audio output path of the STB. This signal is then fed into the TV's loudspeaker(s) 24. This injection operation is implemented using programmable data registers (not shown), on board the audio decoder/driver. These registers are accessible by the CPU 210 over the internal data bus. They typically allow control over the injected tone frequency and its amplitude. Tone duration is controlled programmatically within the acoustic back-link application software.

In addition to the CPU synthesizing the audio output content, it can also recall preloaded audio segments from the memory or bulk storage.

Data streams 222 extracted from the satellite (first) transmission path may carry information such as the programme schedule listings. During the broadcast data preload period and at any other time, this information may be cached in the flash memory or transferred to bulk storage 218 (in the case of a PVR).

There is also a real time clock (RTC) 230 within the STB. Immediately prior to each data preload period, the clock 230 generates an interrupt to the CPU 210 causing it to wake from the standby state (if it is in this state). The CPU then activates those parts of the STB required to recover preload data to flash memory or bulk storage. This includes instructing the programmable tuner 200 to tune to the transport stream (channel) carrier, present on the satellite transmission path that contains the host broadcast transmission.

Many of the functional elements described in FIG. 29 may be combined on a single large-scale integration (LSI) silicon component. In the case of an Integrated Digital TV (IDTV) all the components described in FIG. 29 are resident within the TV chassis.

FIGS. 30A and B show the data flow and formatting in the transmission side as employed by the acoustic back-link format. This is the code generated by the STB in response to a user action. The code data payload is chopped into packets each comprising 32-byte blocks D0 . . . D31, where two padding bytes or dummy bytes (usually 0x0000) D31/D32 are added to the end of each block to protect from the effects of applying an Error Control Code (ECC) algorithm to the payload. A Convolutional ECC (rate ½, K=7) is employed to ensure good multi-path properties in Gaussian and white noise at reasonable complexity. Run Length Limited (RLL) code is further employed to ensure bit synchronization and correct phase locking between transmission and reception. A Data block Frame Sync word (“1110 10111001 0000”) is prefixed to each RLL encoded data block to provide data synchronization.

Frequency-shift keying (FSK) modulation (where bit ‘0’ is represented by 2 cycles of 1000 Hz and bit ‘1’ is represented by 3 cycles of 1500 Hz) is employed to modulate the data into a modulated data block audio signal for transmission from the STB audio output to the TV's loudspeakers 14 and then, via the audio (second) transmission path, to the remote service provider 12.

A Pilot Tone Block is prefixed to the audio signal Modulated Data Block to form a final output data stream The Pilot Tone Block is divided into four parts. The first part is a dual tone to signal the start of acoustic back-link data transmission. The second part is to permit the telephone Automatic Gain Control (AGC) circuit to adjust its sensitivity. Thirdly, a training component may be included, or combined with the second component, to permit echo correction at the remote call decoder 22. Finally, the fourth part is a preamble or “Clock-Run-in” to set-up phase locking in the remote call decoder 22.

FIGS. 31A and B show the data flow for the acoustic back-link format in the receiving side (the call decoder 22 in service provider 12 or the product/service vendor 17). Here a number of techniques which will be familiar to persons skilled in the art are employed. Firstly, a Pilot Tone Detector detects the presence of a single or dual tone at step 300 and employs a comb-resonator to isolate the tone from background noise. Secondly, an FM Demodulator, employing two Matched Filters 302, two Envelope Detectors 304 with Hamming Windows and a Signal Quantifier 306, is used to recover the bit sequence from the FSK modulated signal. “Soft decision” quantification is used to enhance the error correction power of a downstage Viterbi decoder 308. Thirdly, de-packetization 310 and de-interleaving 312 are employed to restore the packet structure. Viterbi decoding is employed to maximise the effectiveness of the Convolutional Code.

A skilled person will appreciate that variations of the disclosed arrangements are possible without departing from the invention. Accordingly, the description of the specific embodiments is made by way of example and not for the purposes of limitation. It will be clear to the skilled person that minor modifications can be made without significant changes to the operation described above.

1. An interactive television system for a television terminal comprising receiving means for receiving signals transmitted via a first transmission path, the system comprising:
means for receiving a user response to information presented at the terminal;
means operable to recognize the user response and to generate a code indicative of the user response;
means for generating instructions at the terminal for a user to set up a second transmission path by which to relay the code to a remote transaction facility; and
means for receiving at the terminal a reply to the code via the first transmission path.

2. The system of claim 1, further comprising means remote from the terminal arranged to receive the code and to generate the reply to the code for the terminal.

3. The system of claim 2, further comprising means for displaying at the terminal a response from the transaction facility.

4. (Cancelled)

5. The system of claim 1 in which the code is relayed in the form of an acoustic signal.

6. The system of claim 5 in which the second transmission path comprises a telephone system.

7. The system of claim 6, wherein the second transmission path is established over a public service telephone network or via a wireless telephone network or via a cable telephone network.

8. The system of claim 4 in which the code is a variable frequency modulation-based code.

9. The system of claim 8 in which the code is a dual tone multifrequency (DTMF)-based code.

10. The system of claim 9 in which the code is user—generated at the telephone in response to a prompt from the terminal forming part of the generated instructions.

11. The system of claim 1 in which the second transmission path comprises a portion through the air between the terminal and a user's telephone by which at least the code is transmitted from the terminal to the transaction facility.

12. The system of claim 1 in which the code is an order number, specifying goods or services.

13. The system of claim 1, wherein the code comprises an identifier for identifying the user or a location associated with or specified by the user.

14. The system of claim 1, wherein the code comprises information relating to a transaction.

15. The system of claim 1, wherein the reply from the transaction facility comprises an acknowledgement of receipt of the code.

16. The system of claim 11, further comprising means for generating an acoustic tone that is operable to cause the telephone to dial a pre-determined telephone number.

17. The system of claim 16, wherein the acoustic tone is a DTMF tone.

18. The system of claim 1, further comprising means for executing an application within the terminal software in response to an instruction from the transaction facility.

19. The system of claim 1, in which the terminal further comprises a display, the means for generating being arranged to present the instructions for the user on the display.

20. The system of claim 1 in which the terminal further comprises a speaker, the means for generating being arranged to present the instructions for the user through the speaker.

21. The system of claim 1, further comprising means for storing user selection transactions at the terminal and in which the information comprises an interactive transaction area listing previous user transactions.

22. The system of claim 21 in which details of a transaction are selectable by a viewer by selecting from a viewed list of transactions.

23. The system of claim 1 further comprising means for displaying interactive promotional material at the terminal, the means for receiving a user response further comprising means responsive to a user selection for saving the interactive promotional material.

24. The system of claim 23 further comprising means for saving order data fields related to user responses entered by a user in response to the display of interactive promotional material.

25. The system of claim 23 further comprising means for replacing saved expired interactive transaction material with current interactive transaction material.

26. The system of claims of claim 1 further comprising means for displaying interactive transaction material, the means for receiving a user response further comprising means operable to recognize the received user response as a response to an offer in the transaction material.

27. A method of interactive communication between a television terminal comprising transmission receiving means, and a remote transaction facility, the method comprising:
receiving a user response to information presented at the terminal;
recognizing the received user response as a request for the information;
generating a signal comprising at least a code indicative of the user response for transmitting to the transaction facility;
generating instructions at the terminal for the user to set up a second transmission path by which to relay the code to the transaction facility; and
receiving a reply at the terminal to the code via the first transmission path.

28. The method as of claim 27 in which the transaction facility receives the code and generates a the reply to the code for the terminal.

29. (Cancelled)

30. The method of claim 27 in which the transaction facility receives the code and sends software for execution by the terminal.

31. The method of claim 30 in which the software is transmitted to the terminal via the first transmission path.

32. The method of claim 30, further comprising receiving the reply from the transaction facility at the television terminal via a television broadcaster.

33. The method of claim 27 in which the second transmission path comprises a portion through the air between the terminal and a user's telephone by which at least the code is transmitted to the transaction facility.

34. The method of claim 33 in which the signal in the portion of the second transmission path through the air occupies audible frequencies.

35. The method of claim 33 in which the signal in the portion of the second transmission path through the air is inaudible.

36. The method of claim 27, wherein the signal comprises information relating to a purchase transaction.

37. The method claim 27, wherein the signal includes comprises a product or service identifier for identifying a product or service requested.

38. The method of claim 28, wherein the reply from the service provider is an acknowledgement of receipt of the code.

39. The method of claim 27 in which the signal comprises a portion that is operable to cause a telephone to dial a pre-determined telephone number.

40. The method of claim 27, wherein the code is a DTMF tone in the second transmission path.

41. The method of claim 28, further comprising displaying the reply from the service provider.

42. The method of claim 27 in which the instructions for the user are presented visually to the user at the terminal.

43. A television signal comprising a response that is a product of the method of claim 27.

44. A computer readable medium encoded with machine-readable instructions for executing the method of claim 27.

45. A computer readable medium encoded with machine-readable instructions for controlling interactive communication between a television terminal, comprising transmission receiving means, and a transaction facility, the machine-readable instructions comprising for:
presenting interactively selectable information at the terminal;
recognizing a received user response as a request for the interactive selection of the information;
in response to the viewer response, causing a code to be generated for transmitting to a remote transaction facility via a second transmission path, the code being indicative of the user response, and generating at the terminal user instructions on setting up the second transmission path; and
receiving a reply at the terminal to the code via the first transmission path.

46. An interactive television system that is operable to communicate with a plurality of remote television terminals, the interactive television system comprising:
means for receiving an acoustic signal transmitted over a voice communication network in response to information presented at one of the terminals,
means for identifying a location associated with or specified by the user;
means for interpreting the acoustic signal to identify user information relating to the information presented at the terminal; and
means for transmitting a response to the identified television terminal for presentation thereon.

47. The interactive television system of claim 46, wherein the acoustic signal comprises an identifier for identifying the television terminal.

48. The system of claim 46, wherein the means for identifying are arranged to use a telephone number to identify the location of the television terminal.

49. The system of claim 46, wherein the acoustic signal comprises information relating to a transaction.

50. The system of claim 46, wherein the information includes a product or service identifier for identifying a product or service requested.

51. The system of claim 46, wherein the response to the terminal is an acknowledgement of receipt of the acoustic signal or a confirmation of a transaction procedure.

52. The system of claim 46, wherein the response to the identified television terminal comprises a control signal for the television terminal.

53. The system of claim 52, wherein the control signal is operable to cause an acoustic output from the terminal to be varied.

54. The system of claim 46, wherein the response to the identified television terminal comprises data.

55. The system of claim 46, wherein the acoustic communication network comprises a public telephone network, cable telephone network or a wireless telephone network.

56. A method of interactive communication between television terminal comprising transmission receiving means and a transaction facility, the method comprising:
receiving a code, over a telephone network in response to information presented at the television terminal;
identifying the specific television terminal from which the response originated;
interpreting the code to identify user information relating to the information presented at the terminal; and
transmitting via a television transmission network a response to the identified television terminal, the response being preferably for presentation thereon.

57. The method of claim 56, wherein the code comprises an identifier for identifying the television terminal and the method further comprises identifying the television terminal using the code.

58. The method of claim 56, wherein the step of identifying comprises using a telephone number to identify a location associated with or specified by the user.

59. The method of claim 56, wherein the code comprises information relating to a transaction.

60. The method of claim 59, wherein the information comprises a product or service identifier for identifying a requested product or service.

61. The method of claim 56, wherein the response to the television terminal is an acknowledgement of receipt of the code or a confirmation of processing a transaction.

62. The method of claim 56, further comprising sending a control signal to the terminal.

63. The method of claim 56, wherein the response comprises a control signal operable to cause an acoustic output level of the television to be varied.

64. A television signal comprising a response that is a product of the method of claim 56.

65. A computer readable medium encoded with machine-readable instructions for executing the method of claim 56.

66. An interactive television transaction system by which transactions can be carried out at a remote location in response to television user action, the system comprising:
means for displaying promotional material on a television screen, including user selectable fields for composing a transaction;
means responsive to a first user input for composing the transaction and to a second user input for storing the proposed transaction for later retrieval; and
a user operable transaction execution facility associated with the retrieved proposed transaction for transmitting data indicative of the transaction.

67. The system of claim 66 in which the transaction is an order for goods or services.

68. The system of claim 66, further comprising:
means for displaying a user selectable list of stored proposed transactions; and
means for retrieving the list for display in response to a third user input.

69. An interactive television system having a terminal comprising transmission receiving means, a television service management device programmed to provide an electronic program guide (EPG), having a first level of functionality, for user selection of services provided to the terminal, the management device also being loaded with a full EPG, having a second level of functionality, for user selection of services provided to the terminal, the service management device being responsive to a received command to upgrade the EPG by enabling the full EPG for use by the user.

70. The system of claim 69 further comprising means for transmitting data at the terminal site.

71. The system of claim 70 in which the remote service provider is responsive to an authorization signal to transmit the command to upgrade to the service management device.

72. The system as of claim 71 in which the authorization signal comprises an authorization code indicative of a payment transaction transmitted by the means for transmitting data.

73. The system of claim 72 in which the authorization code is indicative of a credit card transaction.

74. The system of claim 72 in which the authorization code is a user-purchased sequence.

75. The system of claim 74 in which the authorization code is contained on a user-purchased scratch card.

76. The system of claim 69 in which the EPG further comprises means for generating a pseudo-random key, which key is transmitted by the means for transmitting the data from the terminal to the remote service provider.

77. The system of claim 75 in which the remote service provider is arranged to encrypt transmissions from the remote service provider using the pseudo-random key.

78. The system of claim 70 in which the means for transmitting data comprises means for accessing a telephone network.

79. The system of claim 1, in which the code comprises a portion that is operable to cause a telephone to dial a pre-determined telephone number.
